(19) United States
(12) Patent Application Publication
(10) Pub. No.: US 2005/0114666 A1
(43) Pub. Date: May 26, 2005

(54) Blocked tree authorization and status systems

(76) Inventor: Frank W. Sudia, San Francisco, CA (US)

Correspondence Address: Patent Group;Choate, Hall & Stewart, Exchange Place, 53 State Street, Boston, MA, 02109-2804, US

(21) Appl. No.: 10/949,712

(22) Filed: Sep. 24, 2004

Related U.S. Application Data
(63) Continuation of application No. 09/633,149, filed on Aug. 4, 2000, now abandoned.
(60) Provisional application No. 60/147,696, filed on Aug. 6, 1999.
(60) Provisional application No. 60/149,315, filed on Aug. 17, 1999.
(60) Provisional application No. 60/154,088, filed on Sep. 15, 1999.
(60) Provisional application No. 60/168,002, filed on Nov. 30, 1999.
(60) Provisional application No. 60/169,377, filed on Dec. 7, 1999.

(51) Int. Cl. H04L 9/00

(52) U.S. Cl. 713/175

(57) ABSTRACT

A method is provided for communicating authenticated information concerning a digital public key certificate. A hash-tree data structure is created containing a pre-defined list of possible information, such as authorizations, restrictions, privileges, or validity period notices. The list items may include text and coded values. Each list entry is prefixed with a different random data (blocker) value that is securely stored and infeasible to guess. Each list item is hashed to produce a leaf hash, the leaf hashes are combined to produce a hash tree, and the root node of said tree is embedded into a digital certificate or message that is signed using a private key. In response to a request for authenticated information concerning a digital public key certificate, the certificate authority releases the relevant list item, its blocker value, and other hash values sufficient to authenticate the list item using the root node embedded in the digital certificate.

### 1.1. CROSS REFERENCE TO RELATED APPLICATIONS

The present application claims priority under 35 U.S.C. § 119(e) of U.S. Provisional Patent Applications Nos. 60/147,696, filed on Aug. 6, 1999, 60/149,315, filed Aug. 17, 1999, 60/154,088, filed Sep. 15, 1999, 60/168,002, filed Nov. 30, 1999, and 60/169,377, filed Dec. 7, 1999, the disclosures of which are expressly incorporated by reference herein in their entireties.

### BACKGROUND OF THE INVENTION

1.2. Field of the Invention

This invention pertains to secure and efficient systems for controlling access to data and network resources, and providing privacy and authentication of data, in electronic commerce on the Internet.

More particularly, in a public key infrastructure (PKI) where digital certificates are used to identify digital keys, which in turn are used to perform transactions, there is a need to communicate signer authorization and current revocation status information to a relying party, to allow that party to determine whether the user is authorized to initiate a transaction, and to determine whether the certificate is still valid.

### SUMMARY OF THE INVENTION

The present invention constitutes a system to efficiently create and validate authorization certificates, and to communicate revocation status information.

1.3. Related Art

1.3.1. US Patents
Anderson, U.S. Pat. No. 5,751,812, “Re-Initialization of an Iterated Hash Function Secure Password System Over an Insecure Network Connection.”
Asay, et al, U.S. Pat. No. 5,903,882, May 11, 1999, “Reliance Server for Electronic Transaction System.”
Fischer, A., U.S. Pat. No. 4,868,877 Public key/signature cryptosystem with enhanced digital signature certification
Fischer, A., U.S. Pat. No. 5,005,200 Public key/signature cryptosystem with enhanced digital signature certification
Fischer, A., U.S. Pat. No. 5,214,702 Public key/signature cryptosystem with enhanced digital signature certification
Kocher, P., U.S. Pat. No. 5,903,651, May 11, 1999, “Apparatus and method for demonstrating and confirming the status of a digital signature and other data.”
Merkle, R., U.S. Pat. No. 4,309,569, January, 1982, “Method of Providing Digital Signatures.”
Merkle, U.S. Pat. No. 4,309,569, “Method of Providing Digital Signatures.”
Merkle, U.S. Pat. No. 4,881,264, “Digital Signature System and Method Based on a Conventional Encryption Function.”
Micali & Leighton, U.S. Pat. No. 5,432,852, “Large Provably Fast and Secure Digital Signature Schemes based on Hash Trees.”
Micali, S., U.S. Pat. No. 5,666,416, Sep. 9, 1997, “Certificate Revocation System.”
Micali, S., U.S. Pat. No. 5,717,757, Feb. 10, 1998, “Certificate Issue Lists.”
Micali, S., U.S. Pat. No. 5,717,758, Feb. 10, 1998, “Witness-Based Certificate Revocation System.”
Micali, S., U.S. Pat. No. 5,960,083, Sep. 28, 1999, “Certificate Revocation System.”
Micali, S., U.S. Pat. No. 6,097,811, Aug. 1, 2000, “Tree-based certificate revocation system.”
Sudia, et al, U.S. Pat. No. 5,995,625, Electronic cryptographic packaging, Nov. 30, 1999.
Sudia, F., U.S. Pat. No. 5,659,616, Aug. 19, 1997, “Method for Securely Using Digital Signatures in a Commercial Cryptographic System.”

1.3.2. Foreign Patents
Sudia, et al, WO 96/02993, “Method for Securely Using Digital Signatures in Commercial Cryptographic System,” filed Jul. 7, 1994 (CIP).
Sudia, F., WO 00/22787: Method, system, and computer program product for providing enhanced electronic mail services.

1.3.3. Other References
Adams C. and R. Zuccherato, “Data Certification Server Protocols,” Internet draft, September, 1998.
Adams, C., presentation to NIST PKI CRADA, September, 1998.
Aiello et al., “Fast Digital Identity Revocation,” Proceedings of Advances in Cryptology (CRYPTO-98) Springer-Verlag Lecture Notes in Computer Science.
Ankney, R. and F. Sudia, ANSI X9.45 “Enhanced Management Controls Using Attribute Certificates.” American Bankers Association.
Ankney, R., “Certificate Management Standards,” April, 1999.
Branchaud, M., “Caching the Online Certificate Status Protocol,” Internet draft, April, 1998.
Ford, W. and P. Hallam-Baker, “Enhanced CRL Distribution Options,” Internet draft, August, 1998.
ITU-T Recommendation X.509, “The Directory: Authentication Framework,” 1997.
ITU-T Recommendation X.509, ISO/IEC 9594-8: “Information Technology—Open Systems Interconnection—The Directory: Public-Key and Attribute Certificate Frameworks” (“X.509 Version 4,” Draft Revised, 2000)
Kocher, P., “A Quick Introduction to Certificate Revocation Trees.” 1997.
Malpani, A. and P. Hoffman, “Simple Certificate Validation Protocol,” Internet Draft, Jun. 25, 1999.
Micali, S., “Efficient Certificate Revocation,” MIT, 1996.
Myers, M., R. Ankney, A. Malpani, S. Galperin and C. Adams, “Online Certificate Status Protocol,” RFC 2560, June, 1999.
SetCo, “SET Secure Electronic Transaction Specification, Book 3: Formal Protocol Definition,” May, 1997.

1.4. Definitions and Abbreviations

Periodic Freshness Indicator (PFI) means a predetermined hash value released as shown in Micali U.S. Pat. No. 5,666,416 as proof of the continuing validity of a certificate.

Daily Freshness Indicator (DFI) means a periodic freshness indicator whose periodicity or frequency has been defined to be “daily.”

Freshness Server (FS) means a network server computer that responds to requests for certificate status information by providing a PFI data value.

Recertification means the act by a certificate authority or its designee of issuing the next PFI value, thereby extending the certificate's life for one more period.

Terminal Hash Value (THV) means the final hash value of a series (e.g., H³⁶⁵) that is listed or included in a digital public key certificate or other transaction.

| | |
|---|---|
| CA | certification authority |
| Cert | Certificate |
| CVP | cert validity period (= notAfter − notBefore) |
| DFI | daily freshness indicator (PFI_{D}) |
| H^{X} | the Xth hash value in the hash chain |
| INV | initial “no” value, used to create TNV |
| IRV | initial random value (same as H⁰) |
| KTV | key transition value |
| N₀ | terminal “revoked” value, in cert |
| N₁ | hashes to N₀, indicates cert has been revoked |
| N_{X} | hashes to N₀, to indicate revocation reason |
| PFI_{X} | periodic freshness indicator, of period X |
| RA | registration authority |
| TGS | ticket granting server |
| THV | terminal hash value (for example, H³⁶⁵) |
| TNV | terminal “no” value (per Micali patent) |
| TPR | third party responder |
| TRV | transition release value |
| Yᵢ | same as PFI_{X} |

Other exemplary embodiments and advantages of the present invention may be ascertained by reviewing the present disclosure and the accompanying drawings

### BRIEF DESCRIPTION OF THE DRAWINGS

The present invention is further described in the detailed description which follows, in reference to the noted plurality of drawings by way of non-limiting examples of certain embodiments of the present invention, and wherein:

FIG. 1 is a schematic representation of the process of Merkle tree signing (prior art);

FIG. 2 is a schematic of the extended signature data unit resulting from Merkle tree signing (prior art);

FIG. 3 is a schematic representation of verification of the extended signature resulting from Merkle tree signing (prior art);

FIG. 4 is a schematic representation of the process of auth-tree creation and signing;

FIG. 5 is a schematic of an auth-tree digital authorization string data unit;

FIG. 6 is a schematic representation of the process of tree-wrap creation and signing;

FIG. 7 is a schematic of a tree-wrap digital authorization string data unit;

FIG. 8 is a schematic representation of the process of creating a digital authorization string that requires tree-wrap to verify;

FIG. 9 is a schematic of a digital authorization string data unit that requires tree-wrap to verify;

FIG. 10 is a schematic representation of the process of creating a digital authorization string where tree-wrap is required to recover the blocker key;

FIG. 11 is a schematic of a digital authorization string data unit that additionally requires tree-wrap to recover the blocker key;

FIG. 12 is a schematic representation of the process of creating a digital validity interval string using the blocked tree method; and

FIG. 13 is a schematic of a digital validity interval string data unit using the blocked tree method.

### DETAILED DESCRIPTION OF THE EMBODIMENTS OF THE INVENTION

2. Identity and Authority Systems

Micali 5,666,416 claims a process whereby there is embedded into a certificate any “public key” that can subsequently be used to verify a recertification (or freshness) message from the CA or a related entity. One form of such an embedded public key is the terminal hash value (or THV).

A certificate may contain multiple THVs, which may be associated with different roles or privileges. For example, one THV may signify that the association between the user's personal identity and their use of the given public private key pair remains valid, while another may signify that they possess a certain job role and privileges and entitlements. Then the supplying of PFI updates by a Freshness Server can be made efficient by in effect combining some of the assertions that the THVs make, so as to reduce the number of PFIs required in normal use, preferably to a single PFI per session or message.

In legal terms, it is important to distinguish between “agency” and “accreditation.” Agency is a grant of authority to an agent by a principal, such that the agent can act on behalf of the principal and create legal obligations that will bind the principal, whereas accreditation is a grant of a “status” such as membership, qualification, or access rights, etc. For example, a state bar association may admit an individual lawyer as a member in good standing, but the bar association will not be liable for any act or omission of the lawyer. Likewise a provider of a computerized service may grant a user an access privilege, such as the right to enter a wire transfer, but the user does not thereby become an employee or agent of the wire transfer service. In practice, however, the grant of authority by a principal or an accreditation by a sponsor are encoded and processed in a virtually identical manner. The distinction is one of policy, not of procedure.

For example, a system of authority used by a bank may include the following levels or kinds of privileges:

External Signing Authorities

| | |
|---|---|
| Class A | Authority to sign any document on behalf of the Company |
| | (general officer) |
| Class B | Authority to sign checks, letters of credit, or orders for payment |
| | of money or delivery of securities |
| Class C | Authority to sign signature guarantees and endorsements |
| | on checks |
| Class D | Authority to sign reconcilements, verifications, and certifications |
| | of balances |
| Class E | Authority to sign receipts |
| Class F | Authority to certify lists of stockholders, proxy voting |
| | tabulations, and certificates of destruction of securities, etc. |

Internal Signing Authorities

| | |
|---|---|
| Class 1 | Outgoing money transfer: authority to sign requests -- with no |
| | limit |
| Class 2 | Outgoing money transfer: authority to sign requests -- up to $1 |
| | million |
| Class 3 | Outgoing money transfer: authority to sign “urgent” requests |
| Class 4 | Authority to verify the accuracy/validity of journal tickets |
| Class 5 | Authority to stop payment on a check |
| Class 6 | Authority to sign limited fee payment |
| Class 7 | Authority to sign five or fewer checks |
| Class 7a | Alternate signer for five or fewer checks |
| Class 8 | Authority to sign tax department IRS payments |
| Class 9 | Authority to sign sales orders |

Therefore, under the present invention, a CA acting for an enterprise, such as the bank having the foregoing authority types, can embed into the certificate of the user, an array of THVs, with one for each type of authority the employee might conceivably possess. In addition, there will be one more THV associated with only the user's identity and status as an employee of the enterprise.

To operate such a system, the Freshness Server (FS) will maintain all the IRVs for the THVs that were issued in the user certificate, but release only the PFI(s) corresponding to those authorities currently in effect. If the user remains an employee but is between assignments, and currently has no active signing authorities, the FS will release only the PFIs pertaining to the identity-only THV. The system administrator will make the appropriate entries into the authority table used by the FS, to tell it which PFIs to release.

Whenever a current PFI is issued against any THV in the user's certificate, that PFI will also be understood by the requester (RP) to signify that the identity portion of the user's certificate is still valid. As with other embodiments of this invention, such a system will be greatly facilitated by associating a globally unique ID (such as an IOD) with each THV and PFI, so the RP can easily specify to the FS which THV it wants to validate, and likewise when the RP receives a PFI from the FS (or another source, such as the signer or its own cache) can determine which of the several THVs the PFI can be verified against.

This system of embedding an array of THVs corresponding to different types of signing authority has many benefits. By way of non-limiting example:
The RP can verify both identity and a current authority level using a single PFI.
If a user has more than one type of authority currently in effect, the RP can request only the PFI pertaining to the type of transaction it is seeking to verify.
If the user is between assignments their authority certificate does not need to be revoked.
Likewise, as the user is promoted or transferred to different levels or kinds of responsibility in the enterprise, the certificate need not be revoked or reissued.
   3. Inserting Additional Data Strings

It is possible and useful to insert additional data strings into the processing of certificate or signature validation information within the scope of this invention. Micali 5,666,416 claims a process whereby there is embedded into a certificate any “public key” that can subsequently be used to verify a recertification (or freshness) message from the CA or a related entity. One form of such an embedded public key is the terminal hash value (or THV) that we have discussed at length elsewhere in these disclosures. Alternatively, such a key could be any public key of a public/private signature system, used to verify a unique message from the CA pertaining to the continued validity of the certificate (or signature).

Therefore, in accord with the generalized form of the invention, the data strings to be discussed in this section can be inserted into the validation process as either:
a. A component of any message signed by the CA and verifiable by the special public key embedded into the certificate or signature, or
b. A data constituent of any hash value in the hash chain (wherein such data is disclosed to or readily ascertainable by the validator).

Normally, when such additional data strings are inserted into a hash chain, this will occur in one of the last hash iterations prior to the final iteration, i.e., the embedded THV. It is convenient to refer to such data strings as “period 0 insertions,” which implies that they are inserted right after the period 1 hash value and right before the terminal value.

However, they could also be inserted in (or alongside, or between) other “low numbered” periods (preferably in the final 10 periods). Such data strings will preferably contain a pre-coded field telling which period they are to be inserted, and the manner of such insertion. Inserting strings at various low numbered periods can allow for convenience in inserting various types of data that may be unrelated to each other. To avoid conflict between the revocation function and the data insertion function, we can define or reserve a certain number of pre-THV periods that are solely used for inserting data strings, which could have negative “period” numbers (−1, −2, −3, etc.) to indicate they are not part of the revocation period computation.

In another approach, such data string values could be supplied in the form of an attribute certificate (along the lines described in ANSI X9.45), whether or not digitally signed by a CA or AA, where the hash value of the attribute certificate is inserted into the data stream just prior to the THV. Such an inserted data string, or array of data strings, is in effect “digitally signed” by virtue of its inclusion into the hash chain computation leading to the THV. This has no relation to the signature on a certificate that contains the THV. Rather, the “signature” of the CA is effected by the release of a PFI value, which in order to be verified against the public key (i.e., the THV) must have the data string hashed into the chain, thereby providing irrefutable proof that the CA (or other THV issuing entity) intended to deliver and authenticate such data to whoever possesses the THV (public key) and at least one subsequent PFI (signature value).

There are several means by which additional data strings may be delivered to the entity that seeks to verify the continuing validity of the THV (usually to validate a certificate or signature). By way of non-limiting example, the data strings could be delivered to the recipient/validator:
a. As an “attribute certificate,” preferably unsigned, containing user authorizations and other data strings, delivered to the recipient/validator in the same manner as other certificates, but verified according to the novel methods described herein. In addition to lacking a signature of a CA or AA, such a certificate may also lack a certificate number, validity period, issuer name, subject name, or any data field other than the desired data strings. For this purpose we treat an “attribute certificate” as merely an “array of strings.”
b. Associated with the PFI value (i.e., in the PFI data unit). This constitutes additional information needed to validate the certificate or signature. This information is visible to anyone who can request a revocation check on the underlying digital certificate or signature. It may include information on how to include the associated data strings in the PFI validation computation, e.g., which period numbers, methods of hashing, etc.
c. Incorporated into the underlying document or transaction content, and pointed to somehow, e.g., using a special HTML, XML, or SGML tag (delivered with the PFI) plus an instruction to the recipient/validator to look for and retrieve the data strings from a data field in the document as demarcated by that special tag from the PFI. Normally the document will be encrypted using the key of the recipient. Therefore, this embodiment has the added benefit that the additional data strings can only be viewed by an entity that is authorized to read the document content. This is highly desirable to enterprises and institutions, which do not wish to reveal their employee, customer, or agent authority information to the public.
d. As a URL/URI pointer to a document that is incorporated by reference, which can be retrieved from the stated location. In normal practice, the URL is accompanied by a hash of the document that it points to. Then the URL plus its accompanying hash value are hashed and the resulting hash inserted into the hash chain leading up to the THV, either right before the THV (period 0), or a few periods before.
e. In an associated attachment to a MIME message, where the reference is called out in the PFI value, and it refers to a “file name” that is an attached file to the same or a related message, as for example the first or last message in a sequence.

Certain combinations of the foregoing may also prove advantageous. For example, when the additional strings are contained in a separate document, that is either pointed to by a URL/URI or present in a separate MIME attachment, it will be convenient to use the method of “calling out” the necessary XML/HTML “tag” identifiers within the PFI data unit (e.g., along with the URL/URI), to instruct the recipient/validator which strings to extract from said document. In this manner, a more generic document could be supplied that lists a wide range of possible data strings (representing authorizations, accreditations, restrictions, contract terms, etc.), and the specific tags associated with a given PFI (and its THV) could selectively point to some but not all of such data strings.

The following sections describe in greater detail the possible contents of these additional data strings that are inserted into the hash chain prior to the THV, and which must once again be reinserted by the recipient/validator in order to complete the process of validating the revocation status of a certificate or signature using a current PFI value.

3.1. Data String Insertion Mechanisms

There are various ways in which supplemental data strings could be inserted into the computation, or subsequent validation, of a hash chain. Since most would produce generally equivalent security benefits and processing requirements, it is mainly necessary to uniquely specify a given method, so the recipient/validator can proceed in a fully automated manner.

As a preferred embodiment, the insertion of a data string into hash chain computation can be effected as follows. A data structure may be concatenated that consists of the unique THV OID number, plus a suffix for a data string type code, plus the hash period number to which the value is to be added, plus the data string content itself. In the prior sentence, the term “plus” means concatenation on octet boundaries (alternatively, we could also define an ASN. 1 structure that comprised the same elements).

This concatenated data structure is then hashed down to a single result hash value, and the result hash value is concatenated with the hash chain value called out in the period number field, and then hashed to produce the next period, which may in fact be the THV. Under such an approach, the data string would effectively be added to period number 1, just prior to the THV, though we can call this “period 0”as a matter of convenience.

As an example of the forgoing, consider the following:

| | |
|---|---|
| THV OID: | 1, 2, 1, 12345, 19118, 1, 909011 [a dummy value] |
| String Type Code: | 103 |
| Period to Add to: | 1 |
| Data String: | Valid between 9 AM and 5 PM weekdays |

This information is then hashed to produce resultHash, which is concatenated with the hash chain value for period 1. The combined quantity is hashed to yield the THV.

There are numerous ways of combining these values to accomplish a similar result, and the foregoing is provided mainly as an instructive example. As a further example, the resultHash could be compressed into a symmetric key and combined with the period 1 hash by using the key to encrypt (wrap) the period 1 hash, which then forms the THV.

3.2. Adding a Unique Value

Whatever elements are concatenated with the data string(s) to be inserted, it is desirable to include at least one unique value derived from the THV or certificate. This assures that the resultHash will be different for each THV, even when identical data strings are inserted. Otherwise, common resultHash values could be disseminated on the Internet, freeing the recipient/validator from needing to become aware of (i.e., uniquely process and assume legal responsibility for) the contents of the data strings being inserted.

This result can be achieved by including into the calculation leading to the resultHash one or more of: (a) the THV's globally unique OID, (b) some or all bits from the THV itself, (c) another either random or globally unique data value derived from the THV extension or the certificate that contains it, such as (1) “issuer name plus serial number,” or (2) a separate random value placed in the THV extension for this purpose.

3.3. Phantom Authorization™ Strings

The following represents an alternative embodiment of the inventions disclosed in Section 2, “Identity and Authority Systems,” above.

Prior digital attribute certificate schemes for authorization or accreditation utilize a digital certificate containing an attribute or extension, which contains a parameter (which may in turn contain an OID, a label, a logical filter expression, a text value, etc.) that explicitly encodes some specific authorization or restriction that is to be given effect by a relying party who receives and validates a transaction based on this user's certificate.

A generalized scheme for formatting and creating authorization and attribute certificates is given in ANSI X9.45, “Enhanced Management Controls Using Attribute Certificates.”

As discussed in Section 2, one or more attributes or extensions may be placed into a digital public key certificate, as before, to indicate the user's authority or accreditation to a relying party, with each such attribute or extension containing in addition a separate THV under the present invention, preferably each THV having a globally unique OID to facilitate matching the THV with its associated PFI values, with the proviso that (a) the Freshness Server (FS) will only provide current PFI updates for whichever THV is associated with the user's current level of authority, and (b) the embedded THVs need not contain any indication of such authority, which can be supplied as an insertion string along with the PFI.

This allows a user to retain the same attribute certificate during different phases of their career, without the need for reissuance, but it does not address the need to strongly link authorization data to the certificate while also maintaining strong confidentiality.

For purposes of the following discussion, we will use the term “authorization string” to refer to a code, text, numeric value, or pointer (URL, URI, OID, etc), or any combination thereof, that indicates some specific type or level of user authority or accreditation, or any qualifier thereto (such as a monetary amount), or any restriction on the validity of a user's transaction, or any choice or filter function that combines one or more such authorities or accreditations with any other conditions or restrictions, including explicit and implicit lists (e.g., lists of categories that by prearrangement contain explicit references).

Under the present invention the term “authorization string” encompasses a textual or coded statement (or a list or array of such statements) using any coding scheme for authorization or accreditation, including all those discussed in ECMA Sesame, ANSI X9.45, and the Fischer and Sudia authorization patents, including all authorizations or restrictions that might be capable of being checked and enforced by the recipient replying party (RP) including:
1. document or transaction types, including form numbers or classes
2. signer roles
3. signature purposes
4. monetary values
5. pre-authorized counterparties
6. required co-signatures from any determinate class of potential co-signers
7. modes of delegation
8. minimum or maximum age of the transaction
9. confirm-to requirements, with or without optional or required receipts
10. maximum or minimum reliance limits
11. signer-imposed restrictions
12. times of day and days of the week
13. PFI period numbers during the day or week
14. private key protection levels or methods (e.g., smart required)
15. physical locations of the sender (e.g., GPS coordinates)
16. transaction origins (network address, e-mail address, telephone number, etc.)

Statements may be coded and interpreted affirmatively or negatively, as to either allowed or disallowed authorities, events, or conditions, and may include any combination of such conditions, along with any combination of parentheses, arithmetical operators, logical operators (sometimes called a “filter expression”), and external references to the underlying (or a related) document, signature, certificates, or other ascertainable external information (such as the date and time, location, machine numbers, etc.)

The authorization string may also contain a pointer to (and optionally a hash value of) incorporated terms and conditions or policies that may affect the usage or interpretation of any of the foregoing.

We can now enhance this model by providing that the attribute or extension that is placed into the user's digital certificate, which is then signed by a CA or authorization authority (AA) with a private key, will not contain any expressed authorization strings (e.g., codes, text, or pointers) pertaining to the authority it represents.

Rather, it will contain only a THV, preferably along with its globally unique THV OID, wherein this THV is formed in part by hashing the value of a desired authorization string into the computation that produces the THV, and consequently in order to correctly compute and validate the THV from the PFI values under this system, it is necessary for the relying party (RP) to possess the authorization string, or its hash value, which it has obtained from another source besides a digital certificate.

The essential purpose and effect of this scheme is to place the recipient/validator on notice as to the terms and conditions (e.g., the authorizations, accreditations, and restrictions, etc.) that may apply to this user, certificate, signature, and transaction.

By requiring the recipient/validator to process all this information prior to being able to validate the certificate, we can assure ourselves that he or she has actual notice of it. Then by means of a legal contract, we can require him or her to reject any transaction that is not logically consistent with the authorizations or restrictions. This is also known as “recipient enforcement” of conditions upon the sender.

A further reference for authorization certificates is Sudia et al, WO 96/02993, also published as EP 0771499.

3.4. Embedding Period Data in PFIs

Further to the foregoing, it may be beneficial, when generating the THV for embedding into a certificate or signature, to insert into the hash chain at each iteration a version of the data string insertions together with a statement of the time period during which the PFI value for this period will remain valid. Or alternatively, we can insert the data strings at period 0 as before, and merely incorporate a statement of the validity period of the PFI into the computation for each PFI.

Consider the following sequence of hash computations:
IRV
Hash-365+THV-OID+“Period 365, valid Dec-31-99 from 00:00 to 12:59”
Hash-364+THV-OID+“Period 364, valid Dec-30-99 from 00:00 to 12:59” etc.
Hash-001+THV-OID+“Period 001, valid Jan-01-99 from 00:00 to 12:59”
Hash-000+resultHash—from all other string insertions
THV
   Each succeeding hash value is computed by adding a textual statement of the THV OID, period number, and date/time range for the period, which is hashed together to create the hash value for the prior period, down to the THV.

As will be recalled, the THV OID plus the period number equals the PFI OID. Thus all the associated textual data in the PFI data unit can be considered signed by the CA or THV issuer. To verify such a PFI, one must hash most or all data in the PFI data unit to form the hash value for the prior period, to which must then be added the associated textual strings for the prior period, etc. However these textual strings differ only as to the date and time, and can easily be obtained by decrementing the date-time range by the periodicity interval (daily in the example given above) to form the prior date-time range, and so on, until the THV is reached.

At the last step before the THV, we can perform the period 0 insertion as discussed herein, to include an array of text strings in the final computation, without the need to use them in the intermediate computations. Since the periodicity is known (at least from the THV extension itself), the recipient/validator has all information needed to form and insert the validity period string into the PFI hash-forward calculation, incrementing the interval start-end times for each iteration.

This adds computational overhead to the validation step, which may be mitigated if the recipient has cached a previously validated PFI value, but provides some added certainty that the textual period data from the PFI data unit is “certified” by being linked into the calculation. Conversely, it adds no new security, because the validity period and period number, even if uncertified and not included, is known from the iteration count. After we hash the PFI hash value down to match the THV, we can with infer with 100% certainty the period number and its start-end date and time.

The effect of linking the PFI period data into each hash calculation is mainly esthetic. If the PFI were signed, we could avoid hashing it down if the associated PFI textual data were incorrect or altered. However, this would be a false economy, because verifying the signature would consume far more work factor than hashing down the sequence. Hence, the unsigned and unlinked PFI data unit remains superior from a performance standpoint.

3.5. Phantom Wrap End-User Contracts

We can utilize the mechanism of insertion of data strings into the hash chain validation process to create a legally binding contract between the recipient/validator and the CA or other entity that created and issued the THV. We call this Phantom Wrap.

Sudia, et al, U.S. Pat. No. 5,995,625: “Electronic Cryptographic Packaging,” which is hereby incorporated by reference in its entirety is information on the subject of binding a set of terms and conditions to the usage of a digital public key or digital signature.

The present invention (Phantom Wrap) is another example of the general category of digital rights management, under which some technical mechanism is used to impose various preconditions, e.g., relating to payments and permissions, on an end user who attempts to access or utilize some aspect of the digital content of a message, such as a digital certificate, all or part of which has been “wrapped” using a cryptographic process that enforces compliance with preconditions, which may commonly include evidence of his agreement with certain contractual terms.

Under the present invention, we can effect the requirement that the person who wishes to validate a digital certificate or a signature containing a THV extension must perform an act that constitutes, for legal purposes, an “objective manifestation of intent” to be legally bound by the terms of a contract.

We achieve this by inserting a data string into the hash chain sequence, preferably one of an array of such strings, at “period 0” as previously discussed, wherein said data string constitutes either (a) the text of a contract, or (b) an unambiguous pointer to a place where the text of the contract may be found, such as (1) in a named text file on the user's hard drive, or (2) at a specific URL or URI somewhere on the Internet.

The file name and location or URL may be included in the PFI data unit, or it may be found from an associated unsigned attribute certificate, or may be included in the underlying document, etc. as discussed above.

In addition to the text of the contract, we require the recipient/validator to insert the words “I Agree” or equivalent into the hash computation, which are preferably not contained in the text file, and must be supplied by the user, increasing his level of conscious volitional action.

Thus, to validate the freshness of the certificate or digital signature, the validator must retrieve the text of the contract, concatenate the words “I Agree,” hash the combination to form the resultHash, which is then concatenated with the period 0 hash as discussed above, and hashed to yield the THV.

Such actions are believed to evidence an “objective manifestation of intent” to be legally bound by the contract. This is highly desirable to at least (a) declare a limit of liability, such as $1000, or disclaim all liability, (b) declare a venue where the CA or others can be sued (such as New York City), and (c) make the user agree to enforce the terms and conditions of any explicit authorizations or restrictions, and reject transactions that do not conform to them, and so on.

Due to the way in which Phantom Wrap intervenes, during the revocation checking step, it may be difficult for the contract (as to the single transaction in question) to require the user to perform a revocation check, because he must have already be performing such a check before this restriction will come into play. We can however deny the recipient the ability to validate the current revocation status of a certificate or signature unless they “sign” the Phantom Wrap contract.

To extend the reach of this contract, to provide greater liability protections for the certificate issuer, we can in theory require the user to agree that “next time” he uses one of our certificates, he will validate it, etc., which may work if we can prove that he performed the objective act the last time, which had forward applicability to his future similar actions or non-actions. As precedent for such a “next time” contract, see the sample output from the internet domain name WHOIS command, imposing conditions on an online lookup service offered by Network Solutions, included in the following section entitled “Current Online Contract Example.”

In a further variation, we can require the user to submit evidence of legally binding agreement to our contract in order to receive any PFI values from the Freshness Server. However, this agreement occurs only at the point where the user is seeking to validate the revocation status on a certificate or signature, and hence remains ineffective, by itself, to require him to perform a revocation check.

U.S. Pat. No. 5,995,625 also discloses improvements to add multi-language and multi-user support. Those improvements work by adding further data elements into the computation of the resultHash, such as special XOR values that can transform the output of the contract as represented in various languages to equal the same desired output. The reasoning here is that we are asking the user to combine data values that include the text of the contract (in his language), words of assent (such as “I Agree”), and an XOR string value that will commute those outputs to the desired one. From the standpoint of legal proof of intent to enter into a contract, the act of selecting the appropriate XOR value is still so improbable as to strongly support the conclusion that it was the objective desire of the recipient to agree to be bound by the contract.

All multi-language and multi-user improvements disclosed in U.S. Pat. No. 5,995,625 are incorporated herein by reference and claimed as a further aspect of the present invention.

3.6. Current Online Contract Example

The following is a sample “next time” contract, of unknown legal efficacy, that was included in the output of the Internet domain name WHOIS online lookup command by Network Solutions:

“The Data in Network Solutions' WHOIS database is provided by Network Solutions for information purposes, and to assist persons in obtaining information about or related to a domain name registration record. Network Solutions does not guarantee its accuracy. By submitting a WHOIS query, you agree that you will use this Data only for lawful purposes and that, under no circumstances will you use this Data to: (1) allow, enable, or otherwise support the transmission of mass unsolicited, commercial advertising or solicitations via e-mail (spam); or (2) enable high volume, automated, electronic processes that apply to Network Solutions (or its systems). Network Solutions reserves the right to modify these terms at any time. By submitting this query, you agree to abide by this policy.”—Reply to an Internet “WHOIS” inquiry on 9-12-99.

3.7. Phantom Risk Accounts

Another desirable feature that may be implemented by insertion of data strings into the period 0 hash calculation is the communication of information relating to transaction risk insurance or the existence of escrowed funds to pay damages that may potentially result from reliance on a transaction that turns out to be defective due to forgery or negligence by the certification authority or other digital online service providers.

Because the information associated with a period 0 insertion to compute an embedded THV is necessarily static, this data is best associated with a THV on an individual signature that pertains to only one document or transaction, (as discussed elsewhere in my prior disclosures in this series), but it can also apply to a certificate (that is used for multiple transactions) as well. We will therefore consider the case of a documentary THV risk account, and then generalize to the case of a digital public key certificate.

In prior models of transaction insurance (such as U.S. Pat. No. 5,903,882) a relying party validating a certificate may digitally sign a message to a third party “reliance manager” to request and pay for a signature insurance guarantee up to a pre-determined reliance limit, that will pay compensation to the relying party in the event of certain occurrences, including forgery, identification fraud, negligence in failing to revoke, and so on. Consider the following embodiments.

In a preferred embodiment, a signing party creates a digital document, and prepares to digitally sign it with a private key. Prior to signing, however, it ascertains, from inspecting the document, or consulting a potential recipient, what is the probable loss amount that the recipient would incur in relying on the document which turns out to have one of the stated problems.

The signing party then makes a request to a Freshness Server for a documentary THV that can be used to revoke the signature on the document, in case the signer or another party decides it is no longer prudent for others to rely upon it. This request contains at least (a) the proposed reliance amount and (b) a message digest of the document to be signed, and may also contain the identity of (c) the signer's identity and (d) the proposed relying parties identity, (e) an account number of the signer that refers to a payment account (whether credit, debit, subscription, or billing) established to pay the reliance charges or (f) a form of digital cash payment. The request may also contain or refer to a time varying coverage period or payout amount.

Upon receipt by the Freshness Server (FS) of the foregoing request, the FS allocates insurance capital, or escrows funds, to satisfy any possible claims regarding the transaction, for some specific period of time, and bills the signer a “capital charge” which reflects the probability of loss as perceived in the market for operational risk insurance relating to fraud, forgery, etc., plus a profit on the transaction, also generally limited by market rates for other such transactional capabilities.

Or alternatively, the signer and or recipient may be required to obtain and post standby letters of credit (LOC) payable to the FS for the benefit of any users who are injured due to one or more of the stated perils, where the LOC charge does not begin to run until an amount is allocated to cover a specific transaction, and it terminates after a stated time period, or when expressly terminated by the relying party.

We also provide an “unrely” transaction (to be signed by the sender or recipient) such that if a recipient no longer plans to rely on the transaction, they can free up the LOC credit limit of the sender, or if the signer no longer wishes to be bound, they can “revoke the signature” on the document, provided they do so before a recipient has commenced reliance.

Under the present invention, the general or specific terms of the transaction insurance or escrow account scheme (who pays how much and when, for what coverage, under which reserve paradigm) can be conveyed as period 0 data string insertions. Preferably the general terms are incorporated by reference via a URI+hash, and the terms relative to a specific document will either be embedded into data areas associated with the document, and pointed to by tags, or else form a part of the PFI data unit (for period 0 insertion).

Whenever a THV is to be associated with a document, the period 0 insertion should at least include a hash or message digest of the document itself, folded thus into the THV.

Regarding the security of the scheme, when applied to a certificate that is digitally signed by the CA, then the CA's signature proves to a recipient that the CA has committed to the arrangement. However, when a THV is inserted into the signature on a document, the CA or other liability/trust provider does not digitally sign the THV, so the recipient does not have a non-repudiable signature binding the CA. Adequate evidence of the CA's assent to the insurance or collateral arrangement can be had by:
a. including a signed statement to that effect as another period 0 string insertion, which the recipient can verify if he desires to incur the computational overhead,
b. inferring it from the fact that when queried at a well known network address the CA responded with a valid PFI,
c. preferably establishing an SSL session with the CA, to verify that we are talking to the correct server, to authenticate the source of the PFI,
d. maintaining a secure private circuit (or virtual private circuit) between the verifier and the CA, as would be the case if the verifier were another large bank CA, to authenticate the PFI being received over that circuit,
e. digitally signing the PFI response, including a reference to the terms of financial assurance, when requested by the recipient.

We may provide that any PFI request that does not ask for a signature is merely a status check, and does not render the verifier eligible for the assurance.

As with the other elements added via the “phantom” methodology, the risk management data included in a certificate or signature by the foregoing methods has the advantage that there need be no actual reference to any of it in the THV, nor in any part of the certificate or signature. It is merely implied in the THV OID and the seemingly random THV data field itself.

3.8. Risk Management System

As is well known, transaction risk in a credit card system is generally managed by
a. requiring merchant acceptors to perform an online validity check on the card number, including the transaction amount, type, and merchant ID,
b. checking to see whether the credit card number has been reported lost or stolen,
c. checking for possibly anomalous transactional behavior, such as unusual size, type, location, or timing of transactions,
d. charging a substantial fee, between 2-7% of the transaction amount, billed as a merchant discount, part of which is paid into a reserve find for the payment of claims for unauthorized transactions,
e. providing a dispute resolution mechanism that encourages parties to resolve complaints regarding unordered or defective merchandise, etc.

In the US, under Federal Reserve Regulation E, consumers have very low liability for unauthorized transactions, generally limited to $50, i.e., virtually no liability, hence the need for the reserve fund, and the high charges to pay for it.

3.9. Various Support Processes

As a further functional complement to a generalized suite of tools and processes for validating certificates, the present invention provides program processes to validate the current status of some or all certificates, including by way of non-limiting example:
In a certificate directory.
In a user's e-mail address book.
Attached to (or required by) e-mail passing through a given mail server.
Attached to (or required by) e-mail or other transactions currently being processed, or under review by the client, or stored in the client's archive of pending or closed transactions.
Being presented to create network or server sessions on behalf of users, including establishing session keys using network protocols, such as IP-SEC.
Recently (or previously) presented to establish logins, sessions, or session keys, including current and prior sessions.
   The program processes, can in addition:
Optionally store with the certificates so validated the current PFI value, or they may merely store the freshness proof without actually validating the certificate (leaving that task for the client, or some later batch process).
Operate on a periodic or scheduled batch basis, or upon request from a user or administrator, or upon a subset of certificates selected by the user based on pre-determined or user supplied selection criteria.
Report back to the user the results of such operations, including the number of certificates checked, the tests performed, number of freshness proofs retrieved, number of expired or revoked certificates detected.

Such reports can be presented on the screen, printed, or written to a log file, and may also be transmitted to another party, generally an administrator, for review.

3.10. Look Back Notifications

In addition to localized processes to periodically scan the validity of certificates associated with current or future transactions, it is also desirable to provide a method to notify entities that may have recently checked the validity of a certificate, that the certificate which was then valid, is no longer valid.

As a matter of pre-arrangement between the recipient/verifier (RV) and the Freshness Service (FS), the FS will, upon receipt of notification of revocation or suspension of a certificate or signature that was recently checked by the RV, either (a) directly push a notice of the revocation to the RV, notify the RV to come and pickup the notice at some given location on the network, or else merely place the notice at some location where the RV will periodically (such as daily) come and pick up any such notices that may have been placed there.

Upon receipt of a look back revocation notice on a prior transaction, the RV may optionally review the transaction, to determine if it is still pending, or if delivery can still be countermanded, and if so, decide whether to cancel or countermand the transaction.

3.11. Web URL Based Lookup

Another way to deliver the current periodic freshness indicator (PFI) value to an RV to validate a certificate is for the RV to request access to a web URL belonging to the FS, using the unique THV or certificate ID as the lookup mechanism. In response to this inquiry, the FS will return either (a) the current PFI value (encoded in an ASCII format, such as hexadecimal or base-64), or (b) a notice that the certificate (or signature) has been revoked.

The lookup URL might look like:
www.lookup.valify.com/thv-id/100976543
where 100976543 constitutes a globally unique ID for a certificate, signature, or THV to be checked. To this, the reply in case of a valid certificate could be:
www.lookup.valify.com/pfi/98erf08cjhdsjbw4i8y087ydjndjbf3

Where the trailing characters are a base-64 encoding of the current PFI for that THV. The client's application would then parse and decode the PFI, and use it to validate the certificate.

4. Authorization Data Structures (“Auth-Tree”)

Section 3 above discloses methods of “Inserting Additional Data Strings” into public key certificates. For the most part, this discussion centers on the idea that the additional data strings can be hashed to yield a period 0 insertion, where the strings (which could be one or more unsigned attribute certificates) are bound into the hash chain and used to compute the THV that is inserted into the certificate, whose primary purpose is to verify proofs of non-revocation under the Micali hash-chain certificate revocation system. These elements included material under the heading of “phantom authorization” and “phantom wrap.”

However, it should be additionally stated that there is no requirement to insert those additional strings or their hash values into the hash-chain to be used for revocation checking. The same hash value that was inserted (e.g., at period 0 in the hash chain) can also be embedded directly into the certificate.

In this section, we disclose additional methods to insert such data into certificates, by constructing a variety of chains or trees of user authorization information. These methods can produce potentially very great advantages in terms of keeping the nature of the authorizations secret (by not including them in the certificates directly), and allowing for a very large variety of such authorizations to be administered, granted and revoked for individual users, without any need to reissue the underlying certificate.

4.1. Hash-Tree Digital Signing

Micali and others have disclosed signing a large number of data strings by first creating a hash-tree and then signing only the root node. This is also the basis of Kocher's ('561) certificate revocation system. It allows us to deliver any given item (such as a revocation notice) in a potentially very long list to some recipient, without the need to deliver the entire tree, which might be quite large, or sign each response individually, which might require excess signature computation.

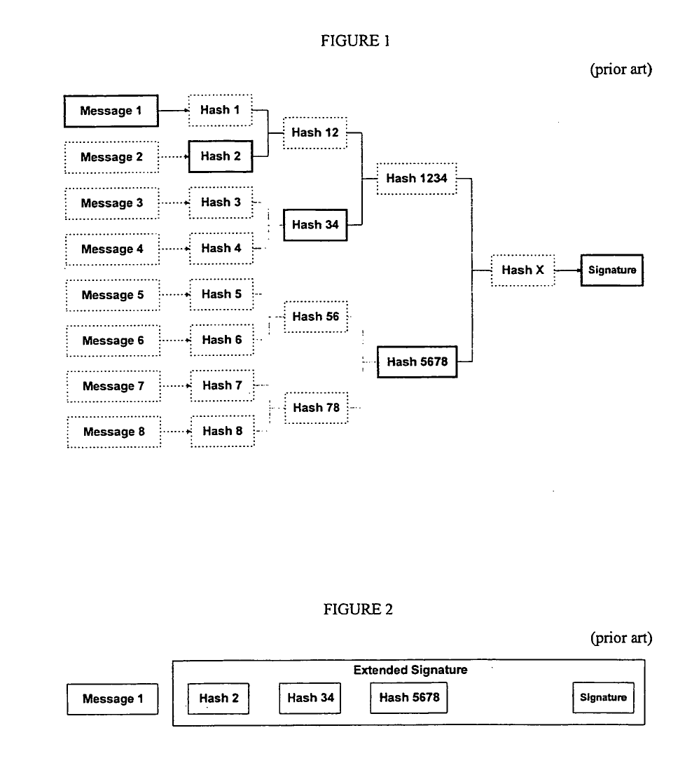

As seen in FIG. 1, once the list is assembled, we construct a Merkle tree, with the hash values of the data strings to be signed forming the leaf nodes, and a single conventional digital signature applied to the root node.

This allows us to sign many objects at once, in a batch signing mode (FIG. 1). However, we need to redefine and lengthen what is considered to be the “signature” of a given data item, to include enough intervening hash values between that item and the root, to allow the verifier to reconstruct the entire relevant pathway. The verifier can reconstruct many of the values himself, so only a few values need be forwarded with the signature. FIG. 2 shows a typical extended batch signature. Digital signing is roughly 10,000 times slower than a single hash function, so performing a few additional hashes adds little to the overall computational burden. Hence, by adding 60 bytes (3×20), the signing process becomes approximately 8 times faster.

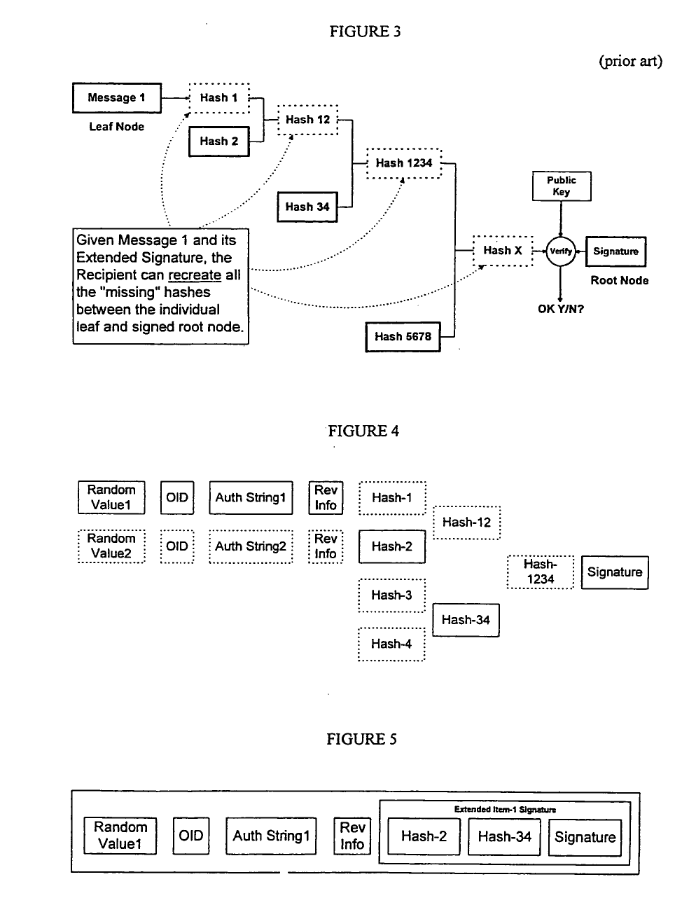

To verify an extended signature, the recipient uses the intermediate hash values to form a complete path between the message and the root node signature, as shown in FIG. 3.

4.2. The Auth-Tree Concept

FIG. 4 depicts a preferred embodiment of the auth-tree invention. Preferably, this (a) compiles a long list containing all possible authorizations, restrictions, and incorporated contract terms that might ever be desired to be granted to or imposed on the certificate subject (user) or his recipient/verifier/relying party (RP), (b) creates a hash tree that encompasses this entire list, and then (c) either digitally signs the root node of the tree, or else embeds the root node within an extension in a digital public key certificate signed by a CA. It can also be used as a period 0 insertion into a hash chain.

As seen in FIG. 4, only the elements bounded with solid lines need be sent in conjunction with the first line of data at the upper right. The elements bounded with dotted lines need not be sent, because they can be inferred from the data that is being sent. As shown in the prior art, the hash tree can be very deep. A table of 1,024 elements can be signed using a tree with a depth of 10 hashes, and a 1 million element table can be signed with a depth of 20 hashes.

The present invention differs from the prior art (authorization certificates) at least in regard to what is being signed, how the resulting signed elements can later be used in electronic transactions, and the remarkable advantages these data structures have over the prior art in the field of electronic document authorization.

Under the prior art it has been disclosed that attribute certificates can be generated which contain fixed strings of authorization data. The authorization strings commonly consist of an OID followed by some attribute-value pairs, such as “role=bank teller” or “max_txn_value=$1000” that may constitute permissions or limitations that apply to the user. The resulting certificate is digitally signed by an issuer using a private key, and the user can transmit it to a recipient. The recipient then checks the certificate and compares it with the accompanying digital transaction, to determine if the content of the transaction falls within the limits of the user's authorities or permissions. If the transaction does not appear to meet the defined restrictions, the recipient rejects it, based upon this comparison. Preferably the recipient is under a contractual obligation to reject the transaction if it does not meet the criteria specified in the authorization certificate.

This methodology is further specified in the technical standard ANSI X9.45 “Enhanced Management Controls Using Attribute Certificates,” by Ankney and Sudia.

Such static attribute certificates under the prior art suffer from several important limitations:
a. If we desire to change the user's authorizations, we must create and mint a new digital authority certificate, that contains the new specification of the user's authorizations and restrictions, and affirmatively revokes the prior one.
b. Many organizations would prefer to keep the specification of their employees' and agents' confidential, but due to the ways that certificates are commonly retrieved from directories, it is difficult to maintain a digital certificate in an encrypted state at all times, to assure that such authorization data will remain confidential.

4.3. Basic Auth-Tree Component Elements

Referring to FIGS. 4 and 5, the auth-tree attribute certificate works as follows—String Table. First, an organization creates a table or list of possible authorizations for a given user. As shown under the prior art, these strings or list entries can be authorizations, accreditations, restrictions, contractual terms and conditions, references to external variables, filters containing some combination of the foregoing, and so on. This list can be quite long, encompassing every possible privilege string, or it may comprise a subset of the potential privileges the certificate subject is deemed likely to ever need.

OID. A globally unique registered object identifier or OID, identifying the attribute type, preferably prefixes each authorization string, followed by an optional value string, indicating one or more permissible values. The values can consist of any data, text or binary, the meaning of which is specified in the system rules agreement (or general legal usage) that is preferably binding upon both the subscriber/sender and the recipient/verifier.

Random Value. Each OID and privilege value string is further prefixed with a unique random value, or blocker, similar to an initialization vector (IV), of preferably at least 128 bits, such that without knowing this random value, which we will call the “key” to the authorization string, it will generally be infeasible for the subscriber/sender to present to the recipient/verifier any verifiable proof that he possesses the authorization conferred by a given string.

This is necessary because the table of all possible listed authorizations will generally be known, so their hash values could be reconstructed, and hence the digitally signed root node, of the user could allow a user to claim all privileges in the table. However, by blocking each string with a unique and opaque value, the issuer (which may be an Authorization Authority, or “AA”) can allow only the currently valid and permitted authorizations to be presented in a verifiable form to the recipient/verifier.

Each auth-tree must generally be constructed for each individual end-user (subscriber) with different “key” blocker values for each privilege string, to prevent end users from obtaining and using a keys from other users to unlock privileges that have not been granted to them. If the AA wishes to retain the ability to grant an additional privilege in the future, if for example a user is promoted to a different job, or subscribes to an additional service, then the AA must retain and securely store all the blocker key values for each user, for the life of the auth-tree cert, to be doled out later as needed.

To minimize the number of blocker key values needing to be securely stored, we can make the blocker key value a regular function of something else, such as an encryption of {the hash of {the privilege string plus its position number in the list plus some unique ID of the end-user}} using a block cipher (such as triple-DES) with a secret key known only to the AA. This would allow us to generate, in the future, the blocker key value for any privilege string in an already issued cert without needing to store a lot of data values, by merely using the secret key to generate the needed blocker key from the given string.

Once the blocker key and the privilege string are released to the user, he already possesses the signature of the AA or CA on the root node of his tree, which is contained preferably in his already issued certificate.

Revocation Info. In addition to granting new privileges to a user within an already existing auth-tree, it is also desirable to be able to revoke a privilege that was previously granted to a subscriber, without needing to revoke and reissue his entire certificate. This can be accomplished by placing a “revocation info” field into our auth-string construct.

This could take the form of (1) a certificate serial number plus an auth-tree leaf number, which can be checked using various online protocols, (2) a unique OID generated to identify the certificate plus the auth-tree leaf number (very similar to (1) but different numbering and formatting rules), or (3) possibly embedding a terminal hash value (THV) as described elsewhere. When deciding whether to rely on a privilege string (with a valid signature and blocker key) the relying party (RP) can make an inquiry to a source of revocation information (such as an OCSP responder, CRL, or reliance manager (RM)) to determine if the privilege is still valid.

4.4. Tree-Wrap™

In addition to conveying privilege and restriction information, it is also desirable to provide for the automatic enforcement of legal contracts, along the model of CryptWrap (Sudia, U.S. Pat. No. 5,995,625, “Electronic Cryptographic Packaging”), and also Phantom Wrap as described above in Section 3.5 above.

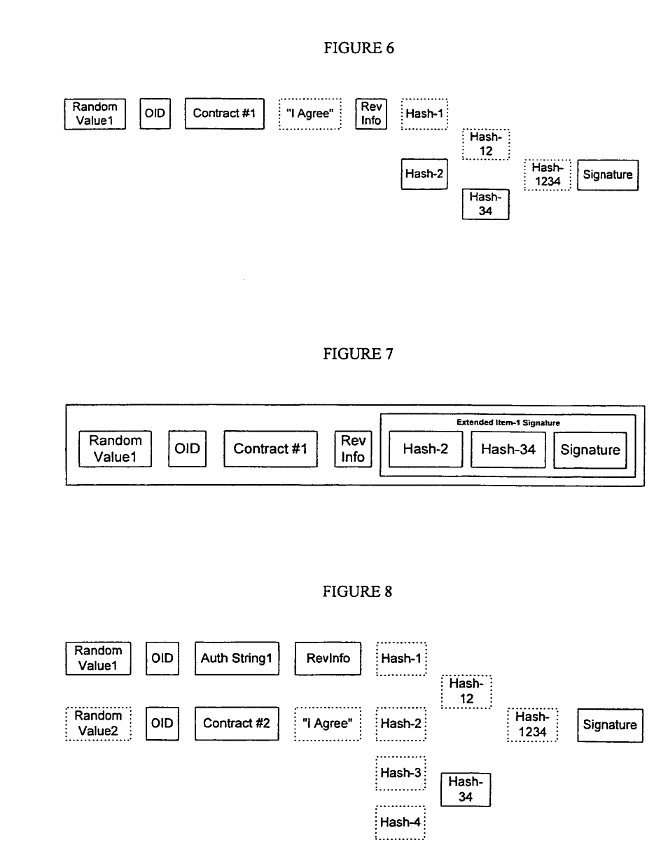

As shown in FIG. 6, a privilege/authorization string is provided in the form of the text of a contract, expressed in a language understood by the recipient/relying party (RP). The actual text of this contract can also be stored elsewhere, being merely represented or pointed to by an OID, URL, URI, etc. The essence of this feature is that in order to verify the data object, the RP is required, as a step in the verification process, to supply the missing string representing words of assent (“I Agree”).

FIG. 7 shows a basic form of tree-wrap, as signed.

Although the drawing shows the signature as a free standing data element, in the more normal case, the “Hash-1234” data element would be embedded into an extension or attribute field in another digitally signed certificate or document. In this most “basic” form, note that we have not made the “assent” step a condition of anything else the RP may desire to do, so it could be omitted.

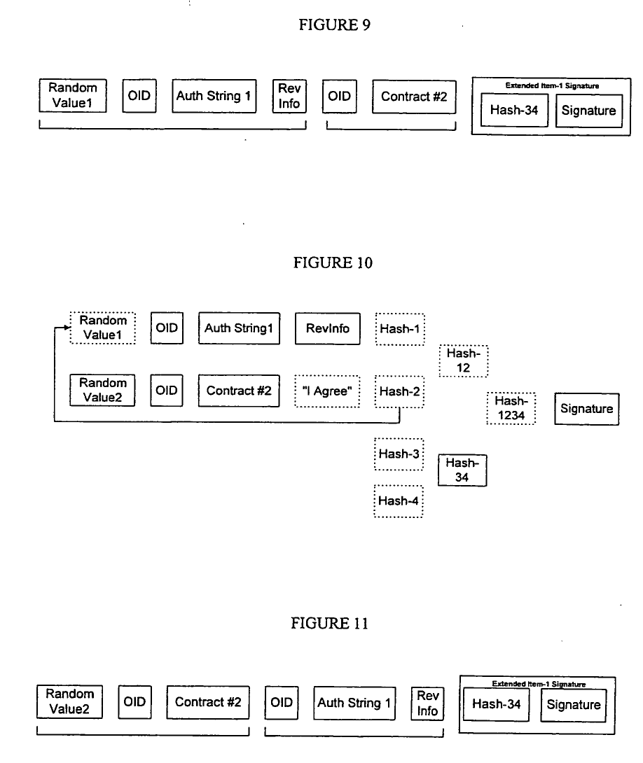

However, the preferred use of tree-wrap would be to force the “assent” step as a pre-condition to something the RP really needs, such as confirmation of the subscriber/sender's authority status. To achieve this, we would insert the contract/assent data units in the verification process of one or more privilege strings, as shown in FIG. 8. FIG. 9 shows the resulting digital authorization data string.

While the tree-wrap step output could be inserted at any point in the computation of the necessary hash values, we show a preferred embodiment in which (a) the “wrap contract” and its (missing) words of assent are formatted as an adjacent entry in the table/list, and (b) the ancillary “hash-2” which would normally be supplied in a tree-hash structure is omitted, forcing the RP to comply with the contract assent requirements in order to generate it, so as to proceed with the privilege verification process.

It will be apparent to one skilled in the art of constructing hash-tree data structures that the output of the tree-wrap step (with its missing words of assent and hash result) could be interposed at a higher position in the tree of nodes, such that the same contractual assent process will be required for all possible privilege string leaves under that given node. Although it is not illustrated, or illustrated as optional, it is preferable to place a random value (unique to that given user/subscriber) in front of the contract text, in the hash calculation, to preclude distribution of one result hash that unlocks all privilege strings of all users. Also note that, as before, it is most likely that rather than signing the root node, we will simply embed the root hash-1234 is embedded into another certificate or message.

In one embodiment, the Auth-Tree data object, including a digital signature on the root node, can be treated as simply another type of attribute certificate with variable contents.

In the alternative, as in Phantom Wrap (where for a given subscriber/end user the root node of the auth-tree is embedded into another certificate of the user), There are several additional options. By way of non-limiting example (a) the then relevant auth tree data elements needed by the RP can be delivered by an online status responder (such as an OCSP responder or RM/reliance manager) during the certificate validation process, or (b) the certificate or OCSP response may contain a pointer or tag value directing the RP to look for the auth-tree privilege strings inside another document, as tagged by the given tag value(s).

A key benefit of these approaches is to allow stronger confidentiality protection for the privilege strings, which may often communicate critical security or business information. When the privilege strings are located inside the associated signed document, then that document is typically encrypted using the key of a recipient that it already known to be authorized to view the document, and verify its author's privilege levels. When they are delivered using an online responder, the responder can ascertain the identity and need to know of the requester before sending back the privilege data, and can encrypt such data in transit to the requester, in a form readable only by the requester.

4.5. Tree-Wrap Access Controls

In addition to interposing a contractual assent step in the verification of a subscriber's currently valid privilege strings within an auth-tree structure, it is also possible to use the output of a tree-wrap step to grant access to other data, such as an encryption key, leaf blocker key, or the like.

As shown in FIGS. 10-11, the tree-wrap process can be used to require contractual assent in order to gain access to a blocker key value to unlock a different leaf of the privilege map.

In FIG. 10 we show a simplified situation where the missing blocker key (random value 1) is simply set equal to the Hash-2 value to be output by the tree-wrap assent step. To gain access to auth string 1, the RP must perform the assent process. FIG. 11 shows the resulting auth string data unit.

More complex data structures may also be provided under which the output of the assent step is formed into a key of a symmetric cipher (such as Triple-DES), and this wrap key is then used to unwrap yet another field (not shown) embedded in the auth-tree structure, that contains a blocker key value for a different leaf of the auth-tree.

One skilled in the art will realize that the output of the assent step can be used as input into processes that: (1) reveal or grant access to a needed hash value at any level in the tree, (2) reveal or unwrap any data value that may be provided in a wrapped field in the tree, and (3) that such revealed or unwrapped data field can be a blocker key that will grant access to another leaf in the tree.

5. Blocked-Tree Certificate Status System

It is desirable to provide a capacity to revoke a user's digital identity rapidly if any facts associated with the user's public key or certificate become or are found to be invalid. Also, as a general principle of computer security, cryptographic materials should not remain in use without reconfirmation for long periods of time.

As a further application of the Merkle tree concepts, as disclosed in Auth-Tree, consider an ordinary user identity certificate containing a public key, signed by a certifying authority (CA). We would like to be able, in effect, to “reissue” or reconfirm this certificate on a periodic basis, such as daily, weekly, 2-hourly, etc. But we would also like this reconfirmation process to be as painless as possible, as to creation, communication, and verification of status update values, while maintaining a high degree of auditable security.

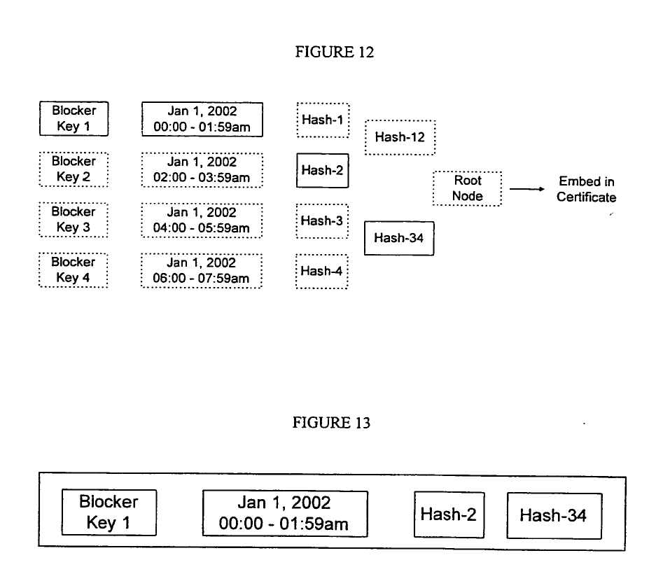

Another way to provide authenticated information pertinent to validity and revocation is as follows. As can be seen in FIG. 12, a list of data strings representing future validity intervals is prepared, each prefixed by a unique blocker key value, which is kept secret by the CA/Issuer. The blocker key and validity period string combinations are hashed to produce the bottom leaf nodes in the hash tree. These are hashed up to a root node, which is either signed or embedded into a user's certificate. The short texts denoting the validity intervals are predictable in advance, but only when the CA/Issuer releases the blocking value for each table entry can it be established that the CA/Issuer intended for the certificate to be valid during that period.

FIG. 13 shows a status update message under this embodiment. This method is distinct from Kocher, Micali, and Aiello. The Kocher and Micali tree systems use a separately signed tree and root for each validity period, and Aiello utilizes a plurality of hash chains. In the present invention we only release the blocker value (and associated hash tree components) to authenticate against the root node embedded in the user's certificate.

It is an advantage of this invention over both Kocher and Micali (U.S. Pat. No. 6,097,811) that the responder does not need to digitally sign each of its responses, but instead needs only to release the appropriate secret blocker key value, nor does the RP need to verify a digital signature on the root node.

In theory, the current validity period string need not be provided, because the RP can predict it. However in practice, we prefer to provide it with the status message, because the additional communication capacity required is not large, and it will greatly aid in deciding which status update message is which, and what to do with it, etc.

We can, if desired, add the previously disclosed tree-wrap elements, whereby some critical element of each entry, such as the blocker value, is obtainable or derivable only if the RP assents to a contractual text. Another scheme might be to simply prefix the validity interval string with the contract, minus the words of assent, and have both prefixed with the random blocker value. Thus, to create a current proof of validity, the RP would be required to insert the required words of assent, and then hash the entire data element sequence (blocker value, contract, words of assent, validity interval) to yield the leaf hash, which when combined with other associated hashes in the tree branch will yield the root node hash, which is embedded into the certificate.

To quickly provide a large supply of plausible pseudo-random blocker key values as required for this method, we can:
1. Generate an IRV and hash it a sufficient number of times to produce a hash chain containing the number of blocker values needed for the desired blocked tree. Such blocker values can be employed securely if they are prefixed onto individual rows in reverse order, with the last chained value used to prefix the first leaf in the blocked tree, etc., so that a previously released value cannot be used to guess a future value.
2. A better approach is to generate a unique secret key of a symmetric cipher, such as Triple-DES, for each certificate to be managed, and use that unique symmetric key to encrypt some simple data value, such as the row number of the row in the hash-tree (prefixed by some suitable initialization vector). In this manner, the storage requirements of the status responder are minimized, because it only needs to retrieve its secret key for that certificate, and encrypt the current period number, to provide the needed blocker value.
3. As a further improvement, it may be preferable to use the secret key described in (2) above to simply encrypt the data string representing the current validity period (known when the blocked hash tree was generated) because that can be easily determined (as to all outstanding certificates managed by the responder) without even the need to store a period number offset value with the secret key.
4. For further efficiency, the CA/Issuer need not generate or retrieve a secret symmetric key for each individual user certificate that it desires to manage using this blocked-tree method. Instead it can use a key formed by hashing at least the certificate serial number plus a single master secret value for its entire system (or for a subset of certificate numbers). Thus, at runtime, when presented with a status request, it can generate the user/cert secret key on the fly, and then use that to encrypt the string representing the current validity period, as just discussed. This can reduce storage and disk I/O on the responder server.
   To represent the foregoing (option d) in programming function notation:
user_secret_key=hash(issuer_master secret|cert_serial_number);
current_block_key=hash(user_secret_key|current_period_string);
   Return to the requester:
current_block_key|current_period_string|needed_hash_values
   where “|” is the string concatenation operator. This minimizes the number of secret keys that must be safeguarded and managed. Of course the need to remember and send the associated hash values may obviate much of the gain produced by this method, since some of these will need to be stored and retrieved. However we have reduced the number of secret keys that must be safeguarded and managed.

5.1. Status Message Sizes

Table 1 shows expected status messages sizes for a blocked-tree revocation system. Typical periodicities for revocation notification intervals include weekly, daily, and 2-hourly.

TABLE 1
Typical Revocation Notification Periodicities and Data Requirements

| Periodicity | N Yrs | Periods | Min Nodes | Depth | H Bytes | T Bytes |
|---|---|---|---|---|---|---|
| Weekly | 1 | 52 | 64 | 5 | 100 | 140 |
| Weekly | 2 | 104 | 128 | 6 | 120 | 160 |
| Daily | 1 | 365 | 512 | 8 | 160 | 200 |
| Daily | 2 | 730 | 1,024 | 10 | 200 | 240 |
| 2-Hr Tmpl | 1 | 3,650 | 4,096 | 12 | 240 | 280 |
| 2-Hr Tmpl | 2 | 7,300 | 8,192 | 13 | 260 | 300 |
| 2-Hr | 1 | 4,380 | 8,192 | 13 | 260 | 300 |
| Norm | | | | | | |
| 2-Hr | 2 | 8,760 | 16,384 | 14 | 280 | 320 |
| Norm | | | | | | |

For each periodicity, the table shows the number of periods, the number of binary tree nodes and tree depth, the number of “hash bytes,” and the “total bytes,” assuming that the blocker key and period range label are each 20 bytes long.

To achieve some minor economy, we provide a “template” version of the 2-hourly periodicity. A template is preferably a pre-determined specification of time intervals that may be unequal, but with the intervals fixed for a period of a day or week. Our base case is 12 2-hour periods per day, and then we delete 10 PM and 2 AM (user local time) as being unnecessary in practice, but retain Midnight (12:00 AM), giving 10 periods per day. This reduction in the period count allows better hash tree utilization without impairing notification quality.

Even with over 16,000 periods, the data message size is only about 320 bytes. This fits easily within a single Internet Protocol (IP) packet, which may be 512 bytes or more. The RP never has to perform more than approximately 14 hash operations to match the embedded value in the certificate, so the RP's computation is never significant. There are NO digital signature sign or verify operations, by either the Responder or the RP/verifier.

5.2. Comparison of CRLs and Auth Certificates

By way of comment regarding the computational processes involved herein, in the prior hash-tree methods of Kocher and Micali the underlying idea is that of signing a CRL, that can then be segmented and delivered in smaller pieces.

The present Blocked-Tree method has a different origin and goal, namely it is more similar to the issuance of a plurality of authorization certificates, one at a time, wherein each of them is only good for a very short time window.

The blocked-tree cert status message is equivalent to an authorization certificate, whose signature (root node) already exists as a field in the user's public key certificate.

It appears preferable to form auth-tree certificates in the existing format of attribute certificates, as given for example in ANSI X9.45, wherein a blocker key will be merely one of the several attributes, and the “signature” on the attribute certificate will be the relevant branch of the hash tree, which must then be linked to the root node in the user's public key certificate.

It may be preferable to provide the certificate validity status messages of the present invention in the form of attribute certificates, wherein the blocker key and short (e.g., 2 hour) validity period are the principal attributes, and the “signature” is the relevant hash tree branch. This is relatively easy since there is a field in the signature known as the “algorithm ID” that is arbitrary, and can be established to mean a hash-branch.

5.3. Blocked Hash Tree Data Sizes

Table 2 shows the unoptimized (full) hash tree data size for the blocked hash tree system, for each periodicity.

TABLE 2
Unoptimized (Full Tree) Data Storage Requirements

| Periodicity | N Yrs | Periods | Leaves | Depth | Nodes | Bytes |
|---|---|---|---|---|---|---|
| Weekly | 1 | 52 | 64 | 5 | 63 | 1,260 |
| Weekly | 2 | 104 | 128 | 6 | 127 | 2,540 |
| Daily | 1 | 365 | 512 | 8 | 511 | 10,220 |
| Daily | 2 | 730 | 1,024 | 10 | 2,047 | 40,940 |
| 2-Hr Tmpl | 1 | 3,650 | 4,096 | 12 | 8,191 | 163,820 |
| 2-Hr Tmpl | 2 | 7,300 | 8,192 | 13 | 16,383 | 327,660 |

When millions of certificates must be issued and managed, storing the full tree requires too much disk space, over 300 GB per million certificates. Therefore it will be preferable to selectively delete some number of data elements, while allowing for easy recalculation of missing ones at runtime.

5.4. Efficiency Issues

The blocked-tree system reduces the computation of either digital signatures or hash operations during the revocation checking process over the prior art. However, the fact that the CA must prepare a separate hash tree in advance for each certificate creates a potentially excessive storage requirement.

In addition, if we omit to store the entire tree, we will need to incur computational expense to regenerate the missing pieces, and this computation may be more complex and time consuming than the RP's verify operation.

The following strategies will make the responder/server operate in a more efficient manner:

5.4.1. Exploiting the 2-Hour Window

As with the hash-chain “freshness” systems disclosed elsewhere, we have two hours during which we can repopulate the online directory/database, so it is not necessary to compute the status values online. Such an approach also reduces the vulnerability of the back end server to hacking, if it is never electrically connected to the Internet.

The fact that computing the response may take more time than verifying it need not have any impact on response time as seen by the RP.

5.4.2. Omitting Parts of the Tree

In a binary hash tree, deleting the bottom layer of leaf nodes causes the data size to be reduced by half. Put another way, the total number of nodes above a given row is equal to the size of the current row minus one.

Therefore deleting the bottom 5 layers of leaf nodes will cause the size to be reduced by a factor of 32 (or 2⁵). Yet under each remaining node (in the sixth layer) there are only 32 hash values to be reconstituted, not a daunting task.

Hash operations are fast, and all antecedent leaf data is easily regenerated, including both period labels and blocker keys, using method (d) described above.

5.4.3. Responder Processing Sequence

An acceptable tradeoff of data size versus speed of regeneration of missing elements can therefore be achieved by, for a given certificate:
1. selecting and storing the information needed to generate the period labels and blocker keys
2. generating the entire blocked revocation tree as described herein,
3. deleting the bottom 5 rows of the table, except for the first 32 periods, thereby shrinking the data storage requirement by 32×,
4. using the stored data elements and chains to generate responses for the first 32 periods, which are sent to the online database during the 2 hour refresh window.

Then, when the time comes to populate the online database for period 33, for a given certificate:
1. delete the hash subtree associated with the first 32 periods,
2. retrieve the data that was used to generate the period labels and blocker keys,
3. regenerate the next 32 period labels and blocker keys,
4. regenerate and store (in the freed up space) the previously deleted portions of the hash subtree for the next 32 periods,
5. transmit the response value for period 33 to the online database, during the 2 hour refresh window.

As will be clear to one skilled in the art, there are other possible ways to trade off storage requirements versus processing speed. We could delete less rows, or more. We can prune or regenerate higher layers of the tree. We can delete all higher level nodes that are no longer needed. We can also, ab initio, delete all higher layer nodes where we expect we can easily regenerate them later. We prefer not to reconstitute the entire table to regenerate high level nodes.

For certificates with small trees, such as daily periodicity for one year, it may be feasible to regenerate most or all of the tree each time we need to compute a response. This is helped by the fact that we can generate the row entries (labels and blocker keys) very rapidly. In such cases, storage may be quite minimal, and in addition, because we have a 24 hour window to repopulate the online database, there is plenty of time to compute whatever values we like. Such a system could run on a relatively low performance server.

5.5. Providing Suspension Notifications

The blocked tree status method can provide the ability to suspend and reinstate a certificate. When preparing the list of validity period notices, we also include a duplicate set of list items, one for each validity period, that indicate for that period the certificate has been suspended by the CA. Upon receiving a certificate status inquiry during a period of suspension, the CA sends the “suspend” message instead of the “valid” message. After reinstatement of the certificate, the CA resumes sending “valid” messages in response to such requests. The suspend list items can be interleaved with the valid list items, or can be arranged as a separate list that is appended to the bottom of the valid list.

6. Lightweight Hash Login Protocol

It is possible to use an iterated hash “signature” scheme like the one discussed in Micali U.S. Pat. No. 5,666,416 to construct a network computer login mechanism, for computers on the Internet or another computer network.

In Micali's system, a CA can generate an Initial Random Value (IRV), hash it forward some number of times (for example 1,000 times) to produce a Terminal Hash Value (THV) which is then embedded into a digital public key certificate. Subsequently, by releasing the “next” prior hash value, also called the periodic freshness indicator (PFI), the CA signifies that the certificate remains valid and unrevoked for the “next” time period as specified in the policy for the THV.

The PFI's of a THV enabled certificate, while indicating continuing validity, do not make a good login mechanism, because normally anyone can obtain them, by claiming they have the user's certificate and requesting a current proof of non-revocation (PFI) from the PFI server. Hence possession of the PFI is not proof of identity.

However, under the present invention, a client/user can register or enroll for access to a web content server (or other computer) using a digital public key certificate (with or without the THV/PFI freshness™ revocation scheme discussed in Micali.)

During the registration process, the client/user (which may be a wallet or a smart card) can generate a new IRV, hash it forward N times (N>1000), retain and securely store the client-IRV (private key), and send the client-THV to the content server, which stores the THV in its database record for that client/user.

Subsequent user logins can be “fast” if the user merely sends in an (unsigned) assertion of their identity, accompanied by a release of the “next” PFI value. The content server can then verify this PFI against the previously registered THV, and this verification can be greatly accelerated by use of the caching optimizations by the recipient.

This verification of the PFI has no relation to any period in time, and only needs to be sequential. We might consider changing the name of the data unit from PFI to TPV (temporary password value) of the like. As a matter of policy it is not necessary that the TPVs be supplied in an exact sequence without gaps. However, the server must never accept an earlier value after it has accepted a later one. It is acceptable to have gaps in the TPV release sequence, but it is a security violation to accept a prior TPV to prevent replay attacks. Any prior value, whether seen or not, is a potential replay attack attempt.

Such a system is similar to a one time password system, several of which are in wide use commercially. For example the Enigma Logic “DES Silver” and Security Dynamics “Secure-ID” tokens are secure hand held devices that calculate an unpredictable “next” password value that can be recognized by the host computer to which they are registered.

The Secure-ID token generates a seemingly random value by encrypting a current time stamp with a shared symmetric (e.g., DES) key, and the Enigma token accomplishes the same thing by encrypting an incrementing numeric value using a shared symmetric (e.g., DES) key. The seemingly random values are then used as passwords for secure login.

The system of the present invention also creates a one-time password, which is the “next” prior hash value linked with the THV that the user generated and registered at enrollment time. Unlike the prior art one-time password systems, which can generate an endless progression of passwords, here we face the practical limit that we probably cannot hash forward more than 10-20 thousand times without incurring performance penalties. (Although these can often be minimized by PFI caching by the content server.)

In practice it may be unusual for a user to log onto a corporate computer system or web server more than 20,000 times under the same identity, since few professional jobs last that long without a change of position and computer login data. If the user does run out of TPVs, they can always generate a new IRV and THV, reregister with the content server, and supply the new THV.

Variations to this concept include by way of non-limiting example:
a. The secret IRV and TPVs to be controlled by the user can be generated and stored on a smart card or other portable device, such as a Palm Pilot, rather than on a desktop PC. This can provide mobility for the user.
b. As with the documentary THV concept, it appears useful to employ a universal numbering scheme, such as the THV/PFI OID numbering system discussed above. The THV can receive a unique number based on an OID assigned to its issuer, which can be the user's OID, plus a “THV” segment, plus a THV serial number. Then the TPVs (just like the PFIs) can be created by taking the THV number and adding a final sequence number for the individual TPV. Such universal numbering can assist the users and content servers in identifying and matching THVs with TPVs.
c. Rather than being generated by the client/user, the IRV, TPVs, and THV can be remotely generated and delivered to the client/user by the “freshness server” (FS). In such a system, the FS can either send all the materials to the user, after assigning a suitable unique THV ID, or it could send the IRV to the client/user and the THV to the content server (CS) directly, at the user's request. Alternatively, at the CS's request, the FS could deliver to the CS a THV while delivering to the client/user a package containing an IRV and other data, encrypted using a password that is either previously known by, or later securely delivered to the user, such as via an independent e-mail.

When the IRV is delivered to the client device or secure wallet, the FS can (a) send a nonce to the device and receive it back digitally signed by the device, with a certificate from the device manufacturer attached (“device challenge”), (b) send a nonce to the device and receive it back along with hashes of the device operating system and the secure IRV-PFI wallet software, all digitally signed using the device's private key (“application challenge”), (c) send the IRV to the device signed by the FS, matching the THV that is delivered separately to the CS by the FS, and receive back from the device a signed receipt including a hash of the IRV value message received, (d) instruct the CS to accept PFIs from the client device based in part on receiving and verifying the device's receipt.
d. Within the spirit of this light weight login protocol, the FS could generate a THV that is in fact the product of adding another series of TPVs at each hashing step. That is, the FS could select two IRVs (A and B) and hash them forward X times (where X is approximately 10,000). However, while hash chain A would be normal, hash chain B would be formed by “hashing together” chain B's prior product with the current product of the chain A. Then the FS would securely deliver IRV-A to the client user, while retaining IRV-B. This method would require (a) exact synchronization and sequencing of the TPVs from both sources, and (b) caching of recent values, so as to avoid having to reconstruct (“zip”) all the prior values. However, with a strictly administered numbering system, and the ability by the CS to request all the necessary values, it could provide an effective method of making login conditional on cooperation by the FS, in effect allowing the FS to revoke the user's access mechanism.

It would of course be far easier for the CS to merely retain a THV from the certificate supplied by the client/user at the time of enrollment, and when presented with the client/user's “next” TPV, just request a “true” PFI from the FS, to verify that the certificate is still valid and unrevoked.
e. In a further variation, a client/user, FS and CS could establish and administer a private PFI system based on the FS. In this system, a CA would issue a certificate to the user containing a THV, where the IRV is retained and administered by an FS, as with a normal Freshness revocation system. However, rather than make the PFIs available to anyone who requests a copy, the current PFI will instead be securely delivered only to the client/user. Handled in this manner, possession of the PFI will itself constitute a form of identification. To assure that only the correct user receives the PFI, it will be preferable to require strong authentication of the party requesting/receiving the THV. This can be done by establishing a “private login” type relationship where the FS holds a THV and the user holds a corresponding IRV which is used solely to request PFIs corresponding to the THV held by the CS. In such a system, the user and the FS may have established a persistent session key, which they can use to create a secure channel, through which the client can send the “next” PFI from its private IRV. Based on this, the FS can send back the next PFI against the THV held by the CS. The user can then send this THV to the CS as proof of identity, when requesting access during a given period, because the possession of the PFI has been administered securely.
f. When receiving, validating, and processing TPVs and PFIs, it will be desirable for the CS to securely journal and timestamp the login transactions it accepts and rejects. The CS can take the incoming TPV from the client, the PFI from the FS, and related data, and transmit it to a timestamp and archive service (TAS). The TAS can receive the request message from the CS and reply immediately with an unsigned “request hash” which is a hash value of what was sent to it. The CS can also give a time within which it wants a digitally signed receipt from the TAS (such as <5 minutes). In response to this, the TAS can place the receipt into a batch signing queue that is scheduled to be signed at or before the time required by the CS, with a possible reduced fee for longer time delays to allow larger batch signing queues to pile up. When the time arrives, the TAS will sign the entire batch using the Micali high speed signing system, and then deliver each receipt to the CS/RP that requested it.
   7. General Timestamp Archive System (TAS)

The foregoing disclosure in sub-section (f) immediately above is also applicable to any general digital signature verification process. In that case, the CS or recipient or relying party (RP) may receive a digitally signed transaction, which it verifies, or sends to a validation processing center (VPC) for verification. The CS or VPC then desire a digitally signed receipt containing the current time, to provide proof that all elements were valid at the time that commercial reliance occurred.

The CS, RP, or VPC will send to a TAS a request message containing at least (a) the hash of the document in question, and optionally the digital signature and document content, (b) the monetary value or type of reliance, (c) the identity of the digital public key certificates that pertain to that signature, and optionally the certificates themselves, (d) any proof of freshness and non-revocation (such as CRLs, delta CRLs, OCSP responses, LDAP responses, Valicert CRT responses, etc.), and (e) an acceptable delay time for receiving a digitally signed receipt (such as <5 minutes).

All these items will be securely stored by the TAS and a receipt message generated containing a description of the materials received, at least one hash over their value, a transaction sequence (receipt) number, and the date and time received by the TAS. This message, which will include a “request hash” over all the materials sent, and including a transaction sequence number, could be sent back to the CS, RP, or VPC immediately without being digitally signed. The receipt may be placed onto a high speed signing queue that is expected to be closed out and batch signed using the Micali high speed signing protocol (MHSSP) within the time frame desired by the requester, perhaps with a difference in payment depending on the timeliness desired. When the queue's closeout time comes, the queue stops accepting messages, is digitally signed using the MHSSP, and the signed receipt (containing the transaction sequence number, time received, and hash values of important data elements) is returned to the requester.

8. Revoke a Session or Association

The freshness THV-PFI methodology can be used to manage or revoke sessions, which can provide an even faster login mechanism than the use of tickets.

8.1. Revoke a Session Key

A client/user can send to a content server (CS) a certificate containing a THV, which serves to authenticate the client. The server and client can exchange or agree upon a unique symmetric session key, which can be used for the current session, and securely stored by both parties for future sessions. The CS will also store the client's THV and any cached PFI values.

Then, when the client wishes to resume the session (login), or continue past some pre-determined maximum session length (such as 8 or 24 hours), the server can receive a new proof of non-revocation, or request it from a freshness server, verify it against the THV and cached PFI values stored in its client association record, and resume or refuse (or cancel) the session based on the results of that verification.

This method of resuming a persistent session can be made more secure by adding a method to rotate the symmetric session keys, inter alia to limit the amount of text encrypted by any one such key. This could be done by causing both parties to transform the key (or agree on a new one) in any pre-determined way known to both of them. At the time of the next login request, both parties automatically progress to the next session key, and the CS checks that the resumed session is still valid by receiving or requesting the current PFI value corresponding to that user's certificate.

To help establish that the correct human is using the computer, the CS can require the user to enter a password, and check it against the client account record.

8.2. Revoke a Password

A client might enroll with a server using a client public key certificate containing a THV. During the enrollment process the server will create a new client record containing at least the THV, any cached PFI values, and an agreed password for the client.

When the client wishes to access the server, the client and server will create a standard server SSL session, and the client will login as usual using the previously agreed password. When checking the password, the server will request a new proof of non-revocation, from a freshness server, verify it against the THV and cached PFI values stored in its client association record, and resume or refuse (or cancel) the session based on the results of that verification.

The CS can require the client/user to select a new password from time to time, while still checking the same THV against up to date PFIs.

8.3. Revoke a Privilege

As will be further discussed below, a client certificate can contain multiple THVs, where one or more of the THVs are serviced with ongoing PFI updates by the Freshness Server depending on the client's role or authority.

At the time of enrollment with a content server, the server can use the client's public key certificate to authenticate the client, and create one or more new client records that contain the for example client's identification data, agreed password, agreed session key, and privileges granted by the active THV's in its certificate, together with the privilege THVs and any cached PFIs associated with those THVs.

When the user wishes to logon, resume, or continue a session (beyond an agreed maximum duration), the server will request a new proof of non-revocation one or more of the user's privileges, from a Freshness Server, verify it against the THV and cached PFI values stored in its client association record, and resume or refuse (or cancel) the client's access to the content governed by a given privilege, based on the verification results.

Note that a universal system for uniquely numbering THVs and PFIs will be useful to assist the server in ascertaining which prior THV a given PFI value goes with, in situations involving multiple THVs for the same client.

8.4. Revoke an AADS Signature Authority

In an Account Authority Digital Signature (AADS) system, as described in ANSI X9.59 and related documents, there is no certificate. Rather, the public key of the user is stored in an account record, similar to a password in a centralized computing system. When a digitally signed transaction, such as a credit card purchase, is received by a merchant, the merchant can send at least the digital signature to the centralized system, which will lookup the account record, use the public key to verify the digital signature, and generally also determine if the transaction is allowable with the user's credit limits, etc. The system then sends an approve/disapprove message back to the merchant, who makes a decision to proceed with the customer's purchase based on the approval message.

Under the present invention we can also place a THV in the account record, and require that the AADS digital signature checking and approval system periodically check with the Freshness Server to obtain a current PFI for the THV before approving transactions based on signatures verifiable by that public key.

Centralized AADS account records and decentralized digital public key certificates represent two different ways of verifying a digital signature in a secure manner, and indeed can be used interchangeably for the same digital public key. Thus, by way of non-limiting example, an enterprise having an AADS system might receive a certificate of an end user, and decide to import the data from that certificate to create an AADS account record. If the user's certificate also includes a THV, then they will naturally wish to import the THV as well and place it into the account record. When verifying digital signatures using the public key stored in the account record, they will generally be required to receive a current PFI value from a Freshness Server.

Normally such an AADS based system will use the PFI caching optimization to reduce PFI verification times. In addition to the THV, there will also be fields in the AADS account record for the last prior PFI value and at least its period number. Further it will be desirable to store the globally unique OIDs of the THV and PFI, as a processing aid.

8.5. Revoke an Association

A digitally signed message (or an account record in a securely managed computing system) may contain assertions of fact about given end users or entities. These will often take the form of either special extensions in an X.509v3 public key certificate, or attributes in an attribute or authorization certificate, such as an assertion that the named user is “an employee of Z corporation,” “a purchasing officer,” “a commercial airline pilot,” “authorized to use system X, screen Y,” “authorized to write credit options,” etc.

Wherever these attributes are stored (database record, ID certificate, authority certificate) they can be accompanied by a securely issued THV, where the source of continuing PFIs is under the control of the person or entity that originally made the assertion. Notably they may often be independent of the revocation of identity in an ID certificate. An ID certificate is, after all, just an assertion by a CA that it “reasonably believes that person X has sole control of the associated private key, and the rest of the facts pertaining to the personal identity of the user stated in the certificate are true.

When checking such non-ID assertions, it will generally be required under the system rules to treat them independently of each other, and to request a current PFI value for the THV corresponding to whichever assertion the RP has an intention to rely upon. After checking the PFI value, and optionally caching the last PFI, the RP will generally send the data to a time stamp and archive service (TAS), and receive back a digitally signed receipt indicating that the data was received and securely stored for later research to prove that the assertion was still valid at the time the RP relied on it.

9. Fast, Secure Guaranteed Delivery Protocols

The THV system can be used to create fast and secure guaranteed delivery protocols. This can be done whenever the parties can agree in advance on at least one THV to be used to communicate the ACK of a message.

For example, suppose two computers wish to establish a session with each other, which may last hours or days, during which time they may communicate 10,000 s of messages to each other. At the time of establishing the session, mutually authenticating each other, and agreeing upon a session key, each computers can select and securely store an IRV, hash it forward (for example) 50,000 times, and securely transmit the resulting THV to the other. These setup messages can be digitally signed by the parties, to provide a high level of security. Then in subsequent communications, they can number each of their messages, and resend each message unless they receive the corresponding ACK value from the other party, where the ACK number matches the message number.

To speed the process and reduce excess chat, the servers can batch the ACKs, and allow a predetermined window during which the ACKs can be returned. For example, computer A may send 10 messages to computer B, and computer B may send back a single packet containing all 10 ACKs for the messages received. Or if some messages were missing, computer B can send back only those ACKs for the message numbers it received. If not all ACKs are received, Computer A will resend the messages corresponding to the missing ACK values. To limit potential inefficiency if the ACK packet is lost, Computer B can delay slightly and send it again.

This method provides significant advantages over other methodologies, because it is both highly secure and extremely fast, a combination generally not found prior systems. As with other applications of iterated hashing, it benefits considerably from the caching optimization, under which prior ACK inverses are stored by each party, whence it is only necessary to hash the next inverse once (or a few times) to verify it.

The method of this section does not allow fast signing of individual messages, since the releases of inverses cannot be permanently linked with a given message. However, it can provide a nearly ideal mechanism to acknowledge receipt of another message which is itself an iterated hash value. This ideality arises because (a) such hash inverses are self authenticating in context against the corresponding THV, and (b) they are necessarily issued in a fixed order, so that a series of ACKs can be given by way of reply, also in a fixed order, and both the substantive inverses and the ACKs can be readily verified and matched with each other.

10. Fast Web Login Using Cookies

A fast, flexible and effective web server login system preferably employs the periodic freshness indicator (PFI) certificate revocation/validation system of Micali, but could also be implemented using other types of freshness proofs.

10.1. Certificate Content/Format

We begin by placing some basic information into an extension in the user's X.509 digital public key certificate. The extension can include the following.

Freshness OID: valify(1) // the OID of the extension

| | |
|---|---|
| Length Indicator | // in bytes |
| Version = 1 | // cannot be part of OID |
| Policy ID | // incorporated terms and conditions |
| TVH Unique ID | // preferably an OID (FS_ID, THV, THV_NO) |
| Hash Algorithm ID | // e.g., SHA-1 |
| Terminal Hash Value | // uchar(20) |
| Periodicity | // in days, hours, or minutes |
| Period-1 Start Time | // relative or absolute |

We may use the short OID 2.6.6.153=Valify, in which case valify(1)=certificate extension, valify(2)=PFI data unit, valify(3)=Server Fast-Login data unit, etc.

It appears expedient to provide a TVH Unique ID that is globally unique for this THV. This can be accomplished by assigning to each THV Issuer (Freshness Server) an OID, under which comes an element for data type=THV, followed by the THV serial number. In this manner it becomes unnecessary to assign unique IDs to individual users or certificates, and allows THVs to be placed in data objects other than certificates.

For example, if 2.6.6.153=Valify, then Valify(4)=thyIssuer, JoesFreshness=thvIssuer(1001), thvData(1)=thvSerialNum, and thvSerialNum(1234)=an individual THV, then THV number 1234 issued by Joe's Freshness Service might have the globally unique number of 2.6.6.153.4.1001.1.1234. Periodicity can be expressed in hours, or as HH:MM, to allow for easy math calculations, etc. Period-1 Start Time can be expressed as an absolute date-time, such as Aug. 1, 1999 at 06:00 AM EDT (−0400), or an offset from the certNotBefore datetime field.

The name and location of the Freshness Responder is being placed in another “well known” cert extension, the Authority Information Locator (AIL), and may be represented using a URL, URI, etc. The AIL may also contain information regarding other sources of revocation status information for the same certificate, including a CRL responder, OCSP responder, Valicert Validation Authority™, or the like.

10.2. Standard RFC 2109 Cookie Prefix

A basic RFC 2109 browser cookie looks like this:

| | |
|---|---|
| serverDomain = .domain.com | // period to left is required |
| allSubdomains = TRUE | // all within base domain can read? |
| serverPath = / | // can restrict to part of a server |
| cookExpireTimeGmt = <time> | // defaults to end of session |
| secureAccess = FALSE | // must be in secure mode to read? |
| variableName = VALIFY_DATA | // one variable per cookie |
| dataValue = <PFI cookie data> | // optionally 64-bit encoded |

The cookie header represents a standard browser cookie as defined in Internet RFC 2109 (February 1997). Each cookie may contain at most one variable name/value pair, with a total maximum length of 4000 bytes. In practice the maximum may be more like 1,200 bytes.

10.3. PFI Cookie Format

The following PFI cookie data can be placed into the VALIFY_DATA field in the above cookie:

PFI-Cookie OID: valify(2)

| | |
|---|---|
| Length Indicator | // in bytes |
| Version = 1 | // cannot be part of OID |
| Policy ID | // incorporated terms and conditions |
| Issue Date/Time | |
| Expiration Date/Time | |
| InitializationVector | // a random value to aid encryption |
| PFI Unique ID | // e.g., an OID (FS_ID, THV, THV_NO, PFI) |
| Hash Algorithm ID | // e.g., SHA-1 |
| Current PFI Hash Value | // uchar(20) |
| Periodicity | // in hours |
| Period Number | // this period |

This cookie can contain the current PFI data of the user. If it is placed in the cookie file of his browser, in a form that can be read by any server, then “any” web server can use it to determine the validity (freshness) status of the user's certificate, without needing any further response or interaction with the user.

The ability of ANY web server to read certain types of cookies is regarded as a design flaw, and its use is deprecated. As a result, in the generic case it may be necessary to write the PFI data unit to the user's hard drive by other means, such as java-script. However, the method described herein is functional within an enterprise, where all web servers share a common second level domain, such as “ibm.com.” Within a second level domain it is permissible for web servers to read and write each other's cookies.

Everything but the Current PFI Hash Value is non-secure, but the other fields help the merchant server to validate the user. At a minimum, we need the unique PFI number, to find the user's cert, THV, or prior PFI in the merchant's cache, unless the certificate has been submitted along with the PFI (or stored in a different cookie, see below).

The presence of explicit issuance and expiration date-times can allow quick assessment of whether the cookie is stale, without having to do the hash calculation. If necessary the server can request a new one from the Freshness PFI Responder immediately. These date values should remain unencrypted.

Alternatively, instead of placing the Expiration Date/Time in the PFI data unit, we could use the cookie's expiration date/time field. We can also omit the Issue Date/Time field, which is unnecessary if the PFI is never issued prior to becoming valid. However, equating the cookie expiration time and PFI expiration time makes the cookie subject to deletion the moment it expires, which may be undesirable. Presence of a stale (but unexpired) PFI cookie can be useful to indicate that the user is signed up for the PFI service.

Following the prior example, if the unique THV number were 2.6.6.153.4.1001.1.1234, then the unique PFI number for period 399 would become 2.6.6.153.4.1001.1.1234.399. While the PFI unique ID is not a user ID, it is indirectly linked, and should be encrypted when possible to minimize its use as a link identifier. However, the method of uniquely numbering all THVs and their associated PFIs will help the system to determine which PFI goes with which THV.

The presence of the initialization vector (IV) prior to the unique user ID can facilitate “good” encryption of the data that follows, if the encryption starts with the IV.

It may in general be unnecessary to sign a PFI data unit, whether in OSCP or in a another proprietary Freshness Responder format, because all the other ancillary fields are implied by, and can be reconstructed from, the PFI hash value alone, and its relation to certified THV information contained in the user public key certificate.

In reply to the merchant request, a PFI responder can (a) provide a normal signed OCSP response with the PFI data fields in an extension, (b) replace the response signature with the PFI hash value, (c) provide the foregoing preformatted cookie data unit, ready to write back to the client's browser, or (d) return a normal RFC 2560 OCSP response based on the CA name and serial number that makes no reference to the THV system.

10.4. User Enrollment

When a web server does certificate handshake with browser, something like the following happens:
1. Server requests user certificate
2. Browser sends user certificate
3. Server receives and verifies user certificate
4. Server sends send random nonce
5. User signs random nonce
6. User fills out other enrollment information
7. Server completes user enrollment process
   When processing and validating the user's certificate (step 3), the server can request the current PFI value to match the THV embedded in the user's certificate. It can request it from the Freshness Responder, or retrieve it from the user's browser. If the PFI-cookie retrieved from the user browser is stale, it can request another from the Freshness Responder, or require the user to do so, and forward it on, in case there is a charge by the Responder and the server does not wish to pay it.

10.5. Login Ticket Cookie Format

While checking the user's data in the foregoing enrollment process, the web server can greatly speed up future web logins by writing back to the browser a second login ticket cookie. The following would be encrypted using a symmetric key known only to the web server (and optionally 64-bit encoded) and placed into the login ticket cookie in a field that might, for example, be called LOGIN_DATA.

| | |
|---|---|
| Ticket-Cookie OID: valify(3) | // fast login ticket data unit |
| Length Indicator | // in bytes |
| Version = 1 | // cannot be part of OID |
| Creation Date/Time | // ticket was created by Server |
| InitializationVector | // a random value to aid encryption |
| PFI Unique ID | // e.g., an OID (FS_ID, THV, THV_NO, |
| PFI) | |
| Hash Algorithm ID | // e.g., SHA-1 |
| Last PFI Hash Value | // uchar(20), this is the “cached” value |
| Terminal Hash Value | // uchar(20), optional, use as backstop |
| Periodicity | // in hours |
| Period Number | // this period |
| User ID on Server = “fsudia” | // to be used for Login |
| User Name = “Frank Sudia” | |
| User Data = <whatever> | // uchar(80), server defined |

All fields except Creation Date/Time should be encrypted using a symmetric key known only to the server. Leaving the date in the clear allows the server to change its key while still being able to read prior cookies. If the server uses the same key for all users, a block cipher such as DES should be used. The presence of a random value in the Initialization Vector field will facilitate “good” encryption of this ticket-cookie. Successful removal of the encryption layer will signify to the server that the cookie is authentic, and one of its own creation.

As before the PFI Unique ID field can allow fast linkage of the THV and PFI values.

The user data field can contain an application-defined user profile created by the web server to meet its needs. It may also contain a password or other supplemental data, such as the state of a password token. The server can then check these against user input, if desired, to afford an additional degree of user authentication.

The cookie-ticket can be written back to the user's browser to facilitate future logins. The information it contains can also be written to the server's hard drive. However, by writing the information back to the client, we eliminate the need to access the server's hard drive during future logins, thereby allowing much faster secure logins of much larger number of users.

10.6. Fast Web Logon Process

We now outline a process to use the foregoing data units to perform an extremely fast web server login, which is scalable to high volumes of simultaneous users.
Send test cookie
Retrieve test cookie
Browser check
   if bad version, sorry you need a more recent browser
Retrieve login ticket cookie and current PFI cookie (in a single read)
   neither there, revert to other login procedure
Process login ticket cookie (step A)
   invalid, revert to other login procedure else decrypt and read user login data fields
Process PFI cookie (step B)
   not there, sorry you need to sign up for freshness service stale, go to responder and get new one, pay X cents
Compare PFI cookie with login ticket cookie (step C)
   invalid, sorry your cert is revoked/expired valid, grant access to content resources

If the PFI value has incremented since the last user logon:
Prepare updated login ticket cookie containing new PFI value
Write back updated login ticket cookie to user browser
Write back new PFI cookie to user browser (optional)

This fast-login procedure generally eliminates the need for the web server to do any time consuming operations, including database lookups or writes, or to create or verify any digital signatures, whether from the user or the PFI responder, during the course of a web server login. All operations required for fast-login can be done in memory with minimal drain on computational resources. (The hash operations and symmetric decrypts can be accelerated using a hardware encryption acceleration board, if desired.) It requires no modifications or plug-ins to currently existing browsers.

Specifically, the web server, having retrieved both a recent PFI cookie and its own prior login ticket cookie from the user's browser, merely removes the symmetric encryption placed over portions of those cookies, determines that the THV Unique ID is the same for both cookies, and hashes forward the current PFI hash value until it matches either the previously cached hash value, contained in the login ticket cookie, or optionally the THV which may be stored alongside it.

If the PFI hashes forward the correct number of periods to equal the cached value, then the user's underlying X.509 digital public key certificate, which originally contained the THV, is also still valid. The cached value, stored alongside the THV in the login ticket cookie, is known to be authentic, even with the certificate gone, because it was sealed there under the symmetric encryption placed there by the server at the time of enrollment.

This procedure delivers security during logon that is exactly equivalent to an X.509 certificate, without doing any digital signature computations or disk accesses.

If the web server does not mind doing disk accesses during the secure login process, then the login ticket cookie can be considerably simplified, to remove the THV and cached PFI information and replace them with a random nonce, again encrypted using the symmetric key of the web server and stored by it. This can allow the server to know that the user requesting access is the same one to which the nonce-cookie was written previously, but the PFI calculations will need to be done using data retrieved from the server's database.

This needs to work either with or without Server-SSL being active. A merchant server should not stop from switching to SSL in the middle of process.

To get merchants into the spirit of writing the PFI cookie back out for others to use, after they have paid for it, we could develop some slogan, such as the Authentication Club,

10.7. Benefits of Generalized Web Logins

The foregoing system represents a considerable enhancement over all prior web login methodologies employing public key digital certificates, especially in cases where all participating web servers can read and share the same current PFI cookie, as is explicitly the case for all web servers within a second level enterprise domain.

When a user has a digital public key certificate containing a THV, the user can enroll for access to web servers all over the Internet, hosted by many different organizations. Each of them will store the user's certificate, and write back a login ticket cookie containing the user's original certified THV.

When the user goes to logon to any web server, that server will check if he has his current PFI cookie, as well as the server's login ticket cookie, in his cookie file. If yes, then the server can just hash the PFI value forward a few times until it matches the THV (or a prior cached PFI) stored in login ticket cookie during enrollment.

If the login ticket cookie is not found, but the PFI cookie is, the server can also execute a disk access to see whether it still has the user's X.509 certificate on file. If so, then the server can continue the login process, using the THV found therein, and write back a new login ticket cookie as if nothing had happened.

If the user does not possess the current PFI-cookie, the server can request it from the PFI Responder service, a public server maintained by the CA or its designee. Upon receiving the current PFI from the Responder, the server can use it to confirm that the user's certificate is still current, and then write the PFI cookie back to the user's cookie file in his browser, where other web servers can access it later during the same period.

If the web server's owner does not wish to bear the cost of purchasing an updated PFI value from the Responder, he can instruct the user to log into central PFI distribution web server, which then performs exactly the same action on behalf of the user, and bills it to the user's account.

10.8. Login Ticket Cookie Mobility Server

The forgoing procedures can provide a fast web login, but the customer's ability to login is based on his possession of the login ticket cookie and current PFI cookie in his PC's cookie file or directory. Hence, his registration under this system will not be transferable to a different personal computer, in case the user travels to another location and wants to keep using the system.

It is therefore desirable to provide a credential server, similar to a wallet server in other protocols, where a user can request to receive a copy of his credentials downloaded to some new machine. This is feasible because the login ticket cookie does not need to change between logins, and the current PFI cookie can readily be obtained from the PFI (freshness) server whenever it is needed.

Due to the close association between the PFI server process and the fast web login system, it would be logical for the “wallet server” to be co-located with and operated by the same organization that operates the Freshness Server. However, this is not required.

When issuing a login ticket cookie to an end user, a content server can request a pass phrase from the user, wrap the login ticket cookie by encrypting it using the pass phrase, and store the wrapped login ticket cookie on the centralized wallet server. It can also store the pass phrase, along with a challenge question, in case the user forgets the pass phrase, a customer care representative may be able to help the user recall the pass phrase and access the login ticket cookie.

When a login ticket cookie is stored in this manner, he main loss of functionality is that the content server will be unable to continually write back the cached PFI value into the login ticket cookie, so the caching acceleration may be impaired.

Another obvious problem is that it may be difficult to delete the login ticket cookie from the temporary computer. This problem can be solved during the login process, involving the stale cookie. When it is detected that the user is at a temporary machine, the content server will immediately write back a very short (end-of session) time limit into the login ticket cookie, in an encrypted area readable and changeable only by itself. Thus the cookie will become useless once the temporary session terminates.

Security can be enhanced by storing a user application password in the area of the login ticket cookie readable only by the content server. If the user has changed their password, they may have to remember an old password. This problem can be addressed however, for those content servers that require a password as part of their application data profile, by updating and replacing the mobility cookie on the wallet server each time the user changes their application password.

Note that although the PFI is an efficient method to indicate revocation status, this fast login protocol can also work with other proofs of freshness substituted in place of it.

11. Fast Multi-Party Transactions

Further to our disclosures of “fast login” methods, it may commonly be the case that when a client logs into a server using a digital certificate for identification, a principal purpose of the client's activity will be to perform a financial transaction (such as a credit or debit card purchase), not merely to access proprietary content.

As disclosed under our “fast login” methods, the client and server will generally perform an enrollment step, during which the server requests the client to sign an unpredictable value (or a timestamp), and checks the resulting digital signature using the client's digital public key certificate.

During this enrollment process, the client's digital certificate (or a related certificate) may also contain information pertaining to a financial account, or other external relationship, such as a credit card number, bank account number, or membership number in a system or service other than that of the server.

Therefore, it is a further feature of this invention (fast login), after verifying the digital signature of the CA or other credential issuer on the client's certificate, or a related certificate of the same client, to add the client's financial account (or other) information in a field in the “Kerberos ticket” that the server writes back, preferably to the cookie file of the client browser, or to some other method of storage, whether or not secure, on the client's system.

Such a “fast transaction” ticket or cookie will generally be encrypted using a symmetric key known only to the server (or family of servers under the same domain) to insure that no one other than the server can read the client's information, and to preserve its value for login and session establishment purposes. In this manner, the ticket (or cookie) functions as a data record for the server, stored on the client, that allows the server to obtain various details about the client in an authenticated manner, without needing to perform any disk I/O operations on its own database.

Said ticket will also preferably contain information that “relates back” to the original digital certificate(s) of the client, such as (a list of one or more) (1) CA name and serial number, (2) certificate OID, and/or (3) THV-OID, etc. that can be used by the server to perform a validity check on the digital certificate(s) in question, without needing to retrieve those certificates. It can also contain the (a) user's account number or ID name on the server that issued the ticket, or another application server that shares a symmetric key with the ticket granting server, as is standard under Kerberos type systems, and (b) other identifying data, such as a password, incrementing counter value, pseudorandom value, challenge phrases, identifying data (hair/eye color, etc.), citizenship, biometric data, etc. to help the server authenticate the client during succeeding logins.

Such a ticket may contain information about one or more client accounts or external relationships, such as credit card numbers, bank account numbers, passport numbers, library card numbers, badge numbers, roles or authorizations, that will be used to assist the server in forming transactions, especially financial transactions with other systems and servers.

Such a ticket may also contain information about the recent status of the financial account or other external relationship, such as a recent credit card limit or available balance, the current balance of a passbook savings account, whether or not the user may be delinquent or suspended with respect to membership requirements of some given system or designation, and so on.

A key benefit of storing account related information, especially account numbers, in the client's “fast login” ticket (in an authenticated state, due to the server's encryption layer), is that when the client logs on again, for example to make a purchase, or to exercise some other right or privilege that pertains to a third party service, the server can prepare a transaction to be sent to that third party service (e.g. a credit or debit transaction) without any requirement to verify a digital signature (on the client's digital certificate) or perform local disk I/O to retrieve the client's account details from the server's local database.

In a related embodiment, the ticket might contain only a hash (or other 1-way mapped data value) of the account information, such that if the client submitted in a future session an unauthenticated version of the account information, the server could nevertheless check to see if it will hash to the same value. This could strengthen the client's privacy, but should not be necessary since the ticket is already private to the server only, and is also has the inconvenience of requiring the client to resubmit the account data.

An advantage of this “fast transaction” method is that the server can form and send a financial transaction to a third-party server without needing to verify a digital signature or perform local disk I/O to retrieve an authenticated copy of the client's account details.

In a further variation, especially when account status information is written back to the ticket or cookie, we may provide means by which the client can view the account data and associated status information. This can be achieved by either (a) encrypting the ticket using a means that the client can decrypt (but not re-encrypt, which would permit unauthorized alteration), (b) separately encrypting a different field in the ticket that contains a copy of the information, using a key known to the client, or (c) writing back a separate record or cookie, readable by the client, containing a copy of the information.

Note: Neither this “fast transaction” method, nor the “fast login” method on which it is based, depends on Micali hash-chain (“freshness”) certificate revocation, since the information that relates back to the certificate, or which permits the current validity status of the certificate to be checked, need not be a THV or cached PFI value. They could just as easily be a “CA name and serial number,” or some other data that uniquely identifies the certificate (which is generally not present), and allows its current validity to be checked.

12. Lightweight Network Time Protocol

12.1. Background

Synchronization of computer time clocks can be an important requirement in a distributed computing system for many reasons. For example, it can be difficult to detect and prove that a computer attack occurred, if the correct sequence of access attempts on different machines is not apparent. Or if digitally signed transactions are to be exchanged between computers for sequential processing, it is highly desirable that documents are not stamped as being received by a receiving computer prior to the time they were stamped as being sent by a sending computer, as this makes it more difficult to introduce them into evidence in a court of law.

Various network protocols exist to provide time synchronization of computer clocks, some of which are secure against inadvertent or malicious tampering. However, to make such protocols secure, it may be necessary to employ public key digital signing to provide message integrity, authentication, and nonrepudiation. To an already complex protocol, secure digital signing and verification adds further computations and delay.

Micali (U.S. Pat. No. 5,666,416) discloses a system for certificate revocation in which an initial random value (IRV=H⁰) is chosen, and then hashed forward a predetermined number of times to produce a terminal hash value (for example THV=H³⁵⁶) which is embedded into a digital public key certificate and signed using a private key. Then the issuing CA or another designated entity releases, according to a predetermined schedule, the succession of prior hash values (H³⁶⁴, H³⁶³, H^{356-P}, etc.) for each time period, that we call periodic freshness indicators (PFIs) where each such release constitutes a recertification that the public key certificate containing the THV remains valid.

This method affords advantages over other certificate revocation methods, because the message size and computation of the verifier or relying party is low. The work factor to sign or verify a digital signature is equivalent to about 10,000 hash computations. Rather than needing to validate digital signatures, the recipient need only receive or request the current PFI value, hash it forward a number of times equal to the current period count, and check whether the result equals the terminal hash value, embedded in the certificate whose validity is being recertified. The embedded THV acts like a certified public key, and the PFIs act like signatures, but the PFIs cannot be used to sign messages, so their meaning is limited to indications of time and sequence.

12.2. Network Time Protocol

This system of Micali can be implemented to provide a lightweight, efficient, and secure network time synchronization protocol. For this purpose we give the PFI a new name, and call it a “periodic time indicator” or PTI. Rather than merely making the PTI value available for downloading or request from a directory, a PTI server can serve as a precise, secure, fast network time source, that “puts” the next PTI value to the server at a precise time, and receives back a fast acknowledgement (ACK) from the client.

If the ACK is received later than the desired time sync accuracy or tolerance, then a more cumbersome secure network time synchronization protocol can be invoked, to provide the desired synchronization, prior to the next PTI put. Or, if the time granularity selected was small enough (e.g., 10 minutes) it may be sufficient to simply wait for the start of the next period, rather than worry about small drifts occurring during the 10 minute period.

As a further optimization, even where a very fine periodicity has been selected (e.g., 30 minutes or less) that would result in large numbers of hash computations to verify the PTI against the THV, it is acceptable to “put” the PTI at more widely spaced intervals, such as every 12 hours, with reset during the next 10 minutes employed only if the hourly “put” fails. The caching of prior PTI values by the client computer can allow use of very fine grained time intervals with a minimal computational penalty.

The PTI can also serve as a PFI; if the responder withholds it, the client's certificate will be considered at be revoked or suspended.

A detailed description of the process is as follows:
1. A CA will issue to an entity, such as a computer in a distributed computing network, a public key certificate containing a THV extension, as disclosed in the Micali scheme, while retaining and securely storing the IRV and optionally the sequence of pre-computed PTIs, for future release.
2. During certification, the computer (“client”) being certified will also generate a separate ACK-IRV and ACK-THV for use in this protocol, and submit its ACK-THV to the CA (e.g., along with its public key), where the client retains and securely stores the ACK-IRV, to generate ACK-PTIs to serve as time protocol acknowledgements (ACKs), and CA retains the client's THV, to verify the ACK-PTIs sent by the client.
3. A predetermined time synchronization interval, such as “every 2 hours,” is agreed between the client and CA. This is the frequency with which the CA or its Time Responder will issue the PTI values, and “put” them to the client.
4. As in our most recent filing, the release of each PTI value by the CA corresponds to the beginning of a well defined time period, defined as the starting time (which can be either an absolute time or an offset from the certNotBefore datetime), plus the number of periods times the period length.
5. In this protocol, at the commencement of the well defined time period, the CA or a designated PTI server, will send the next PTI value to the client computer, as a single network message, to mark the arrival of that precise time, for purposes of system clock synchronization.
6. The client computer will have a process listening for the PTI, and upon receiving an apparent PTI value, will immediately hash forward the presumed number of times, to verify that the PTI is valid, and the next time period has indeed begun. If the server has been turned off for some time, it may be several periods behind.
7. To improve efficiency, the client computer can securely store the next prior PTI value in a cache, and merely hash the new PTI value forward a single time, to see if it matches. Such secure caching can enable very fine granularity without undue increases in computation, due to large numbers of small time periods.
8. After the client computer has received and verified that the next PTI is genuine, by hashing forward, either to the THV, or to the last cached PTI, then the client will issue its next ACK value, that is, an ACK-PTI against its own ACK-THV that it submitted during the certification process.
9. Upon receipt of the client ACK, the CA (or its designated time responder) will verify the client ACK, by hashing it forward the correct number of periods, to see if it matches the THV originally submitted by the client computer, or else the most recent ACK (client PTI) that it has previously verified and securely stored in its cache.
10. If the CA Time Responder does not receive the ACK within the expected time (e.g., less than 1-2 seconds), it can retry the current period PTI, to see if it can elicit an ACK from the client. Likewise, if the client already sent its ACK, but receives a retry, it may assume the first ACK was lost, and resend its ACK.
11. If the ACK is still not received after a reasonable period of time, the CA Time Responder may assume that the client (or the network) is down, forbear from further resends, and reinitiate the process for the next period.
12. This time sync process is robust, because as long as the client has its certificate with the THV that was embedded by the CA at the time of issuance, the process can always be restarted, and the client can compute the correct time from the declared semantics of the THV and PTI.

If operated with last-PTI cache optimization, this lightweight secure network time protocol can provide PTI-ACK response time in the range of 100-500 milliseconds, at 5-10 minute intervals, and if a period is missed, the protocol will restart itself in 5 or 10 minutes. These tolerances are more than adequate for most distributed computing systems.

13. High Speed Digital Signing

In any online digital service, a critical problem arises due to the computational expense of signing and verifying digital messages. The slowness of these operations can threaten the commercial viability of such services, because even a moderate transaction volume can exceed the ability of the system to perform these time-consuming operations, even with assistance from hardware accelerator boards.

Speed improvements are being made all the time, and certain operations (e.g., RSA signature verification with a short exponent) require less effort than others. However, the process of digitally signing receipts and proofs of freshness or revocation can be greatly speeded up by employing a hash tree system as described in Micali, U.S. Pat. No. 6,097,811.

Under this system, thousands or even millions of records can be signed simultaneously. This is achieved by building a hash tree, similar to that shown in U.S. Pat. No. 6,097,811, except that the leaf nodes of the tree consist of normal hash values to be digitally signed. Preferably each of these should be numbered or sorted into an order, to aid in creating and reconstructing the tree, if needed. Then a binary hash tree is constructed by hashing together each pair of leaf hash values below it, until finally a root node hash is produced, and this root node hash is digitally signed using a private key.

As is the case with Kocher (U.S. Pat. No. 5,903,651) such a tree can serve as a digital signature for any part of the data, because the “signature” can be defined to consist of the original leaf hash value, plus each side node that contributed on the way up, plus the final root node hash value, plus the digital signature on that root value. It is much faster to deliver to a requesting party a message signed in such a manner, rather than to sign each message individually.

In our case, the Freshness Server need not sign its responses, because the PFIs are self authenticating. However, at other stages in the validation process, users and participants need receipts, confirmations, and acknowledgements, in relatively high volumes, from other participants in the system.

Therefore, in addition to the Freshness Server, we can provide an OCSP server, reliance server, validation processing server, transaction archiving server, and merchant content server, each of which is enabled with the unpublished high speed signing capability. In each of these servers, we are enabled to keep up with the high throughput by spooling off to a file or database partition the hash values of all transactions needing to be signed during some given interval, such as 1 second (to minimize latency). Then once we have closed out that batch, we begin spooling the next 1 second worth of transaction hash values to another file or partition, and commence building the hash tree for the first such set, digitally signing the root node of that tree, and then returning to each requesting user the digitally signed hash tree “branch” that corresponds only to their transaction.

In a system that is primarily batch or offline, we can accumulate many more transactions before building the hash tree, because other participants are less concerned about latency, thereby creating an even greater savings in computational resources needed to sign such a larger number of transactions.

A message or request to such an online service may contain a flag indicating whether it is a batch or an online transaction, and based on this flag, the server may place the reply message for that transaction into either a smaller or larger batch, depending on the speed with which the user desires to receive the response.

This speed flag can be further enhanced to comprise a numerical value or code indicating the permissible time delay (in seconds) which might be set to 0 (e.g., as fast as possible) when there is an actual human user waiting for a confirmation message, or some larger number of seconds, minutes, or hours, when the information requested back will be used as part of an e-mail or overnight batch process.

Instead of using a numerical time value, we can also establish by pre-agreement a set of codes (e.g., A, B, C, etc.) that each signifies some acceptable range of time delay, along with potential penalties if the agreed service level is not met.

Additional information maybe found in U.S. Provisional Patent Application Ser. No. 60/143,852, filed Jul. 15, 1999, the disclosure of which is expressly incorporated by reference herein in its entirety.

1. (canceled)

2. A method of managing authority associated with holders of public key certificates, comprising:
determining a plurality of initial random values, wherein each of the initial random values corresponds to a particular type of authority granted to a user;
applying a one-way hash function N times to the each of the initial random values to obtain a plurality of final hashed values;
a certificate authority issuing a public key certificate to the user that includes the plurality of final hashed values digitally signed by the certificate authority;
the certificate authority issuing, at T1, a first set of periodic freshness indicators corresponding to application of the one-way hash function to the initial random values M1 times, wherein M1 is a number of refresh intervals from the date of issuance of the digital certificate to T1; and
in response to a change of authority granted to the holder after T1 and prior to T2, the certificate authority issuing, at T2, a second set of periodic freshness indicators corresponding to application of the one-way hash function to a subset of the initial random values M2 times, wherein M2 is a number of refresh intervals from the date of issuance of the digital certificate to T2 and wherein the subset of initial random values is less than all of the initial random values and corresponds to the change of authority granted to the holder.
